(19) United States
(12) Patent Application Publication
(10) Pub. No.: US 2007/0039289 A1
(43) Pub. Date: Feb. 22, 2007

(54) EQUINE HOOF BOOT ASSEMBLY

(76) Inventor: Catheleen B. LeCompte, Barrington Hills, IL (US)

Correspondence Address: MERONI + MERONI, P.O. BOX 309, BARRINGTON, IL, 60011, US

(21) Appl. No.: 11/204,470

(22) Filed: Aug. 16, 2005

(51) Int. Cl. B68C 5/00

(52) U.S. Cl. 54/82

(57) ABSTRACT

An equine hoof boot assembly enables a user to remedy a select equine hoof disorder, and comprises an elastic hoof boot, a boot insert, and a select medicament. The hoof boot comprises an inner boot surface, an optionally ornamental outer boot surface, a distal sole-opposing portion, and a proximally-extending, wall-opposing portion. The boot insert comprises select viscoelastic foam, a distal insert surface, a proximal insert surface, and a substantially uniform relaxed insert thickness. The distal insert surface is removably engageable with the inner boot surface at the sole-opposing portion. The medicament is releasably received by the boot insert and the boot insert is compressibly form-fit to a hoof cavity for remedying the select hoof disorder. As the proximal insert surface is compressibly form-fit to hoof cavity, the select medicament is releasable from the proximal insert surface for topically treating the select equine hoof disorder.

### BACKGROUND OF THE INVENTION

1. Field of the Invention

The present invention generally relates to an equine hoof boot assembly for outfitting an equine hoof. More particularly, the present invention relates to an assembly, method, and kit for either therapeutically outfitting an equine hoof or for ornamentally outfitting an equine hoof.

2. Description of the Prior Art

It is not uncommon for a horse to develop an abscess on any of its hooves. Common methods for remedying hoof abscesses include drilling a hole into the hoof which then must usually be packed and soaked. To soak a horse hoof, farriers often recommend that horse care takers purchase any number of hoof-soaking boots, such as the so-called “EZ” brand boot or the DAVIS brand boot. The primary problem with these types of boots is that they often irritate the coronary band, the growing band of the hoof. Horses then often develop a secondary infection, which secondary infection then requires further treatment(s).

The foregoing briefly sheds light on the necessity that inspired the present invention. Equines frequently stand in mud and human care takers of equines must often do the same. Human care takers in such situations, however, often don their shoes with some type of prior art galosh or rubber as a means to protect their shoes. During such an episode, the author contemplated that if a horse hoof could be outfitted with a galosh or similar other overshoe or boot constructed and formed to be properly outfitted upon a horse hoof, the use of awkward, clumsy soaking boots that often lead to secondary infections of the coronary band could be eliminated. Notably, secondary infections of the coronary band can lead to malformations in the hoof as it grows or dynamically develops. Further, it is notable that the coronary band is essentially that boundary between soft tissue and hard tissue, similar to the cuticle on a human phalange. Just as an injured cuticle results in the malformation or other disruption to the human fingernail, so too does an injured coronary band result in disruption to the hoof wall.

It is further noted that, as donned upon many horses, the visual appearance of a typical therapeutic hoof boot is often less than desirable. If the aforementioned horse galosh or horse boot could be made from inexpensive materials, but structured so as to more effectually outfit a horse hoof, any number of color combinations could be easily incorporated into the design as a means to enhance the visual appearance of the therapeutic hoof boot assembly or otherwise ornamentally outfit the horse hoof. For example, show horses are often ornamented with various riding colors. If a user were desirous of outfitting her show horse with hot pink colors, hot pink hoof boots could be provided for both ornamenting the horse's hooves as well as providing therapeutic treatment therefor, if ever required. A search into the state of the art reveals, however, that a number of articles attachable to an equine hoof are known in the prior art. Some of the more pertinent prior art relating to equine hoof boots and the like is briefly described, hereinafter.

U.S. Pat. No. 601,541 ('541 Patent), which issued to Anderson, discloses a Horseshoe. The '541 Patent teaches a rubber base ring having a central open portion and recessed on its upper, rear portion for the reception of the frog of the hoof, and a slitted rubber hoof band or envelope provided with fastening means. Notably, the '541 Patent teaches an elastic hoof-receiving/protecting device sized and shaped to lie in inferior adjacency to the coronal band of the distal portion of an equine limb.

U.S. Pat. No. 609,551 ('551 Patent), which issued to Lang, discloses a Non-Slipping Horseshoe. The '551 Patent teaches an adjustable horse shoe or boot having a sole consisting of a sheet of flexible material provided with a slot or recess which extends forwardly from the rear edge of the sole and terminates at a distance from the toe or front edge thereof, dividing the sole into two adjustable sections which are connected by the unrecessed front portion of the sole and which can be expanded or contracted for varying the size of the horse shoe and an upper extending upwardly from the edge of said sole. Notably, the '551 Patent teaches an elastic hoof-receiving/protecting device sized and shaped to lie in inferior adjacency to the coronal band of the distal portion of an equine limb.

U.S. Pat. No. 2,041,538 ('538 Patent), which issued to Gash et al., discloses a Horseshoe. The '538 Patent teaches a horseshoe comprises of a resilient material such as rubber and is either molded or shaped so that on being attached to the hoof of the horse by any suitable means the resilient material conforms to the external contour of the hoof and is retained in position thereon without fastening means formed separately from the shoe. The upper end of the horseshoe terminates below the fetlock of the horse. U.S. Pat. No. 3,236,310 ('310 Patent), which issued to Quick, discloses a Self-Fitting Boot Type Horse Shoe. The '310 Patent teaches a hoof boot that is form-fitted to the hoof of a horse by heat shrinking the materials used. Notably, the '310 Patent teaches an elastic hoof-receiving/protecting device sized and shaped to lie in inferior adjacency to the coronal band of the distal portion of an equine limb.

U.S. Pat. Nos. 4,189,004; 4,503,914; 5,588,288; 6,516,594; and United States Patent Application Publication No. 2003/0167739 all further teach flexible hoof-receiving protecting devices of various types, all of which appear to be sized and shaped to comprise a proximal terminus that will lie in inferior adjacency to the coronal band of the distal portion of an equine limb.

It will be seen from a further review of the above-referenced patents and other prior art generally known to exist, however, that the prior art does not teach a low cost equine boot assembly or galosh assembly and/or kit for outfitting an equine hoof as a means to either therapeutically treat a select equine hoof disorder or as a means to ornamentally outfit the equine hoof, wherein the equine boot assembly comprises a hoof boot, a boot or hoof insert, and a select medicament. The prior art thus perceives a need for a low cost equine boot assembly or equine galosh assembly for outfitting an equine hoof as a means to selectively therapeutically treat a select equine hoof disorder or ornamentally outfit the equine hoof, wherein the equine boot assembly comprises a hoof boot, a boot or hoof insert, and a select medicament.

### SUMMARY OF THE INVENTION

Accordingly, it is an object of the present invention to provide a low cost equine boot assembly or galosh assembly and/or kit for outfitting an equine hoof as a means to either therapeutically treat a select equine hoof disorder or as a means to ornamentally outfit the equine hoof. To achieve this and other readily apparent objectives, the present invention provides at least one select, anatomically-specific hoof boot, at least one boot insert, and a select medicament. Each hoof boot comprises a select elastic material, an inner boot surface, an outer boot surface, a distal sole-opposing portion, a proximally-extending, wall-opposing portion, an anterior toe region, medial and lateral quarter regions, and a posterior heel region. The anatomically-specific hoof boot is selected from the group consisting of a fore leg hoof boot and a hind leg hoof boot. The wall-opposing portion of the fore leg hoof boot proximally extends from the sole-opposing portion at the anterior toe region in a first angle of inclination and the wall-opposing portion of the hind leg hoof boot proximally extends from the sole-opposing portion at the anterior toe region in a second angle of inclination. The second angle of inclination is greater in magnitude than the first angle of inclination, it being recognized that the fore hooves and the hind hooves differ in terms of anterior obliquity.

Each boot insert may also be thought of as a hoof insert and is preferably constructed from or comprises a select viscoelastic foam such as so-called “memory foam.” The viscoelastic foam or similar other compressive material has interstitial pores for releasably receiving the select medicament. The boot insert further comprises a distal insert surface, a proximal insert surface, a peripheral insert surface, and a substantially uniform relaxed insert thickness. The peripheral insert surface extends intermediate the distal insert surface and the proximal insert surface, the width of which is equal to the relaxed insert thickness. The distal insert surface is removably engageable with inner boot surface at the sole-opposing portion. Hook and loop fastening means or adhesive attachment means may optionally be utilized to removably fasten or attach the distal insert surface to the inner boot surface.

The select medicament is incorporated to the design of the hoof boot assembly and/or kit for effectively treating a select equine hoof disorder. Any number of homeopathic treatment solutions (such as a vinegar and water solution) could be releasably received in the interstitial pores. Further, common brand name solutions and/or agents such as HOOF HEAL brand solution, THRUSH BUSTER brand solution, FORSCHNER'S brand hoof pack agent or similar other hoof pack agents can also be releasably received by the interstitial pores for topically treating the select equine hoof disorder, as may be required. Further, certain antibiotics and/or drawing agents may be cooperatively associated with boot insert for treating the select equine hoof disorder. The interstitial pores and the select medicament together cooperatively function as a means for applying medicament when the boot insert undergoes compression by a sole and a frog.

Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of my patent drawings, as follows:

FIG. 1 is a fragmentary left lateral side plan view of a distal portion of a left fore equine leg as shown in phantom with certain distal portions thereof outfitted with an alternative embodiment of a first anatomically-specific hoof boot.

FIG. 2 is a fragmentary left lateral side plan view of a distal portion of a left fore equine leg as shown in phantom with certain distal portions thereof outfitted with an alternative embodiment of a second anatomically-specific hoof boot.

FIG. 3 is a fragmentary left parasagital-type cross-sectional view of a distal portion of a left fore equine leg showing certain distal portions thereof outfitted with the alternative embodiment of the first anatomically-specific hoof boot.

FIG. 4 is a fragmentary left parasagital-type cross-sectional view of a distal portion of a left hind equine leg showing certain distal portions thereof outfitted with the alternative embodiment of the second anatomically-specific hoof boot.

FIG. 5 is a top plan view of the alternative embodiment of the first anatomically-specific hoof boot.

FIG. 6 is a top plan view of the alternative embodiment of the second anatomically-specific hoof boot.

FIG. 7 is a fragmentary bottom plan view of certain distally terminal equine hoof structure as outfitted with an equine shoe.

FIG. 8 is a bottom plan view of the alternative embodiment of the first anatomically-specific hoof boot.

FIG. 9 is a bottom plan view of the distally terminal hoof structure as outfitted with the equine shoe shown in FIG. 7 and as further outfitted with the alternative embodiment of the first anatomically-specific hoof boot shown in FIG. 8.

FIG. 10 is a top plan view of an alterative embodiment of a boot insert and a fragmentary diagrammatic depiction of a bottled first select medicament being applied to the boot insert.

FIG. 11 is a side plan view of the alternative embodiment of the boot insert illustrated in FIG. 10.

FIG. 12 is a fragmentary negative impressional perspective view of a hoof cavity as is compressibly form-fit upon the first boot insert.

FIG. 13 is a fragmentary side plan view of a distal portion of a left fore equine leg showing certain distal portions thereof outfitted with a preferred embodiment of the first anatomically-specific hoof boot, the outer surface of which is provided with select ornamental polka dot coloration.

FIG. 14 is a perspective view of an open kit package containing the preferred embodiments of the first and second anatomically-specific hoof boots, first and second boot inserts, a generic bottled medicament, and certain fastening means.

FIG. 15 is a fragmentary right parasagital- and anatomical-type cross-sectional view of a left fore equine leg showing certain distal portions thereof outfitted with an alternative embodiment of a first anatomically-specific hoof boot assembly.

FIG. 16 is a fragmentary right parasagital- and anatomical-type cross-sectional view of a left hind equine leg showing certain distal portions thereof outfitted with an alternative embodiment of a second anatomically-specific hoof boot assembly.

FIG. 17 is a top plan view of a preferred embodiment of the first anatomically-specific hoof boot.

FIG. 18 is a top plan view of a preferred embodiment of the second anatomically-specific hoof boot.

FIG. 19 is a top plan view of a preferred embodiment of a boot insert and a fragmentary diagrammatic depiction of a second bottled medicament being applied to the boot insert.

FIG. 20 is a side plan view of the preferred embodiment of the boot insert illustrated in FIG. 19.

FIG. 21 is a top plan view of the preferred embodiment of the boot insert illustrated in FIG. 19 as inserted in the preferred embodiment of the first anatomically-specific hoof boot.

FIG. 22 is a top plan view of the preferred embodiment of the boot insert illustrated in FIG. 19 as inserted in the preferred embodiment of the second anatomically-specific hoof boot.

FIG. 23 is a fragmentary right medial diagrammatic view of a shod left fore equine leg showing certain anatomical distal portions thereof in broken lines as parasagitally depicted and as outfitted with the alternative embodiment of the first anatomically-specific hoof boot assembly having a proximal terminus distally adjacent to a coronary band.

FIG. 24 is a fragmentary right medial diagrammatic view of a left fore equine leg showing certain anatomical distal portions thereof in broken lines as parasagitally depicted and as outfitted with the alternative embodiment of the first anatomically-specific hoof boot assembly having a proximal terminus proximally adjacent to a coronary band.

FIG. 25 is a fragmentary right medial diagrammatic view of a shod left fore equine leg as outfitted with the alternative embodiment of the first anatomically-specific hoof boot assembly having a proximal terminus distally adjacent to a coronary band with certain portions thereof broken away to show an equine shoe as received in a wall-opposing groove.

FIG. 26 is a fragmentary right medial diagrammatic view of a left fore equine leg as outfitted with the preferred embodiment of the first anatomically-specific hoof boot assembly having a proximal terminus proximally adjacent to a coronary band with certain portions thereof broken away to show the preferred embodiment of the boot insert sandwiched intermediate a distal wall terminus and an inner boot surface.

FIG. 27 is a fragmentary right parasagital diagrammatic view of a shod left fore equine leg as outfitted with the alternative embodiment of the first anatomically-specific hoof boot assembly having a proximal terminus distally adjacent to a coronary band.

FIG. 28 is a fragmentary right parasagital diagrammatic view of a shod left fore equine leg as outfitted with the alternative embodiment of the first anatomically-specific hoof boot assembly having a proximal terminus proximally adjacent to a coronary band.

FIG. 29 is a fragmentary right medial side view of a left fore equine leg as outfitted with the preferred embodiment of the first anatomically-specific hoof boot assembly having a proximal terminus distally adjacent to a coronary band showing parasagital depictions in hidden lines.

FIG. 30 is a fragmentary right medial side view of a left fore equine leg as outfitted with the preferred embodiment of the first anatomically-specific hoof boot assembly having a proximal terminus proximally adjacent to a coronary band as shown in hidden lines along with certain parasagital depictions in hidden lines.

### DETAILED DESCRIPTION OF THE PREFERRED EMBODIMENT(S)

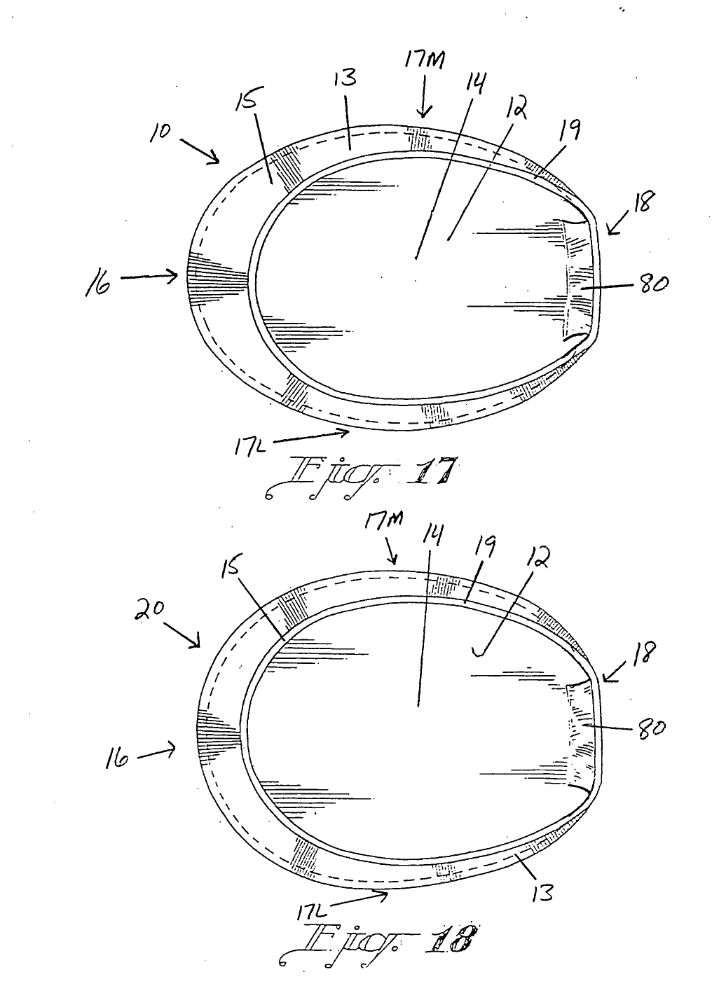

Referring now to the drawings, the preferred embodiment of the present invention concerns a hoof boot assembly, which, when outfitted upon an equine hoof, may function as either a therapeutic device or as an ornamental device (or as both a therapeutic device and an ornamental device, as described in more detail hereinafter). In this regard, it is contemplated that the hoof boot assembly may be presented in an unassembled state in the form of a hoof boot kit 90 for outfitting a select equine hoof, which hoof boot kit 90 is generally illustrated and referenced in FIG. 14. Notably, fore leg hoofs and hind leg hoofs differ in certain aspect(s), particularly with regard to the anterior obliquity, and thus it is contemplated that the hoof boot kit 90 may comprise hoof boot assemblies designed for outfitting either a fore leg hoof or a hind leg hoof (or both).

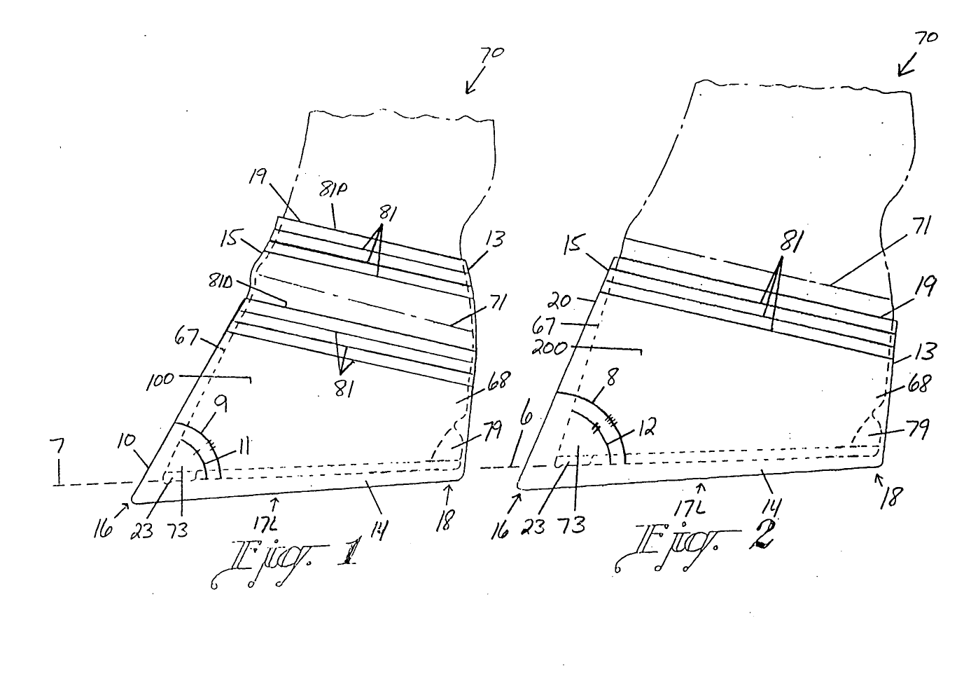

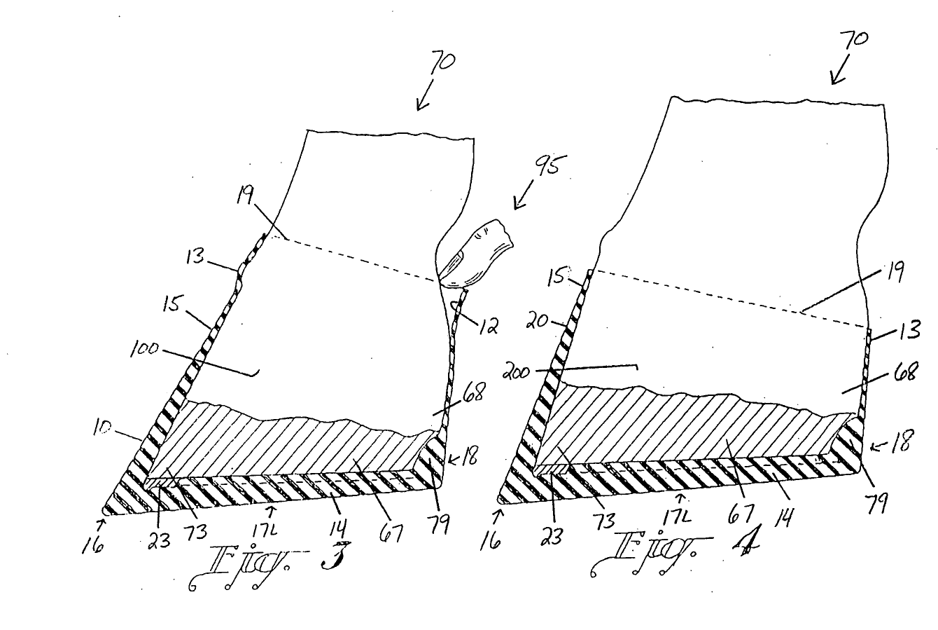

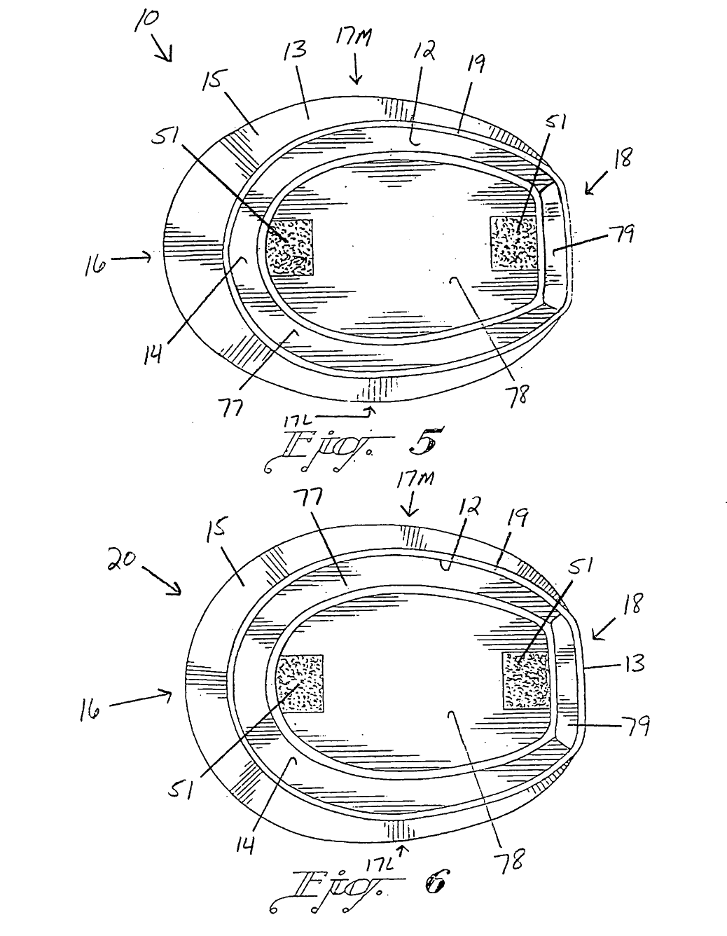

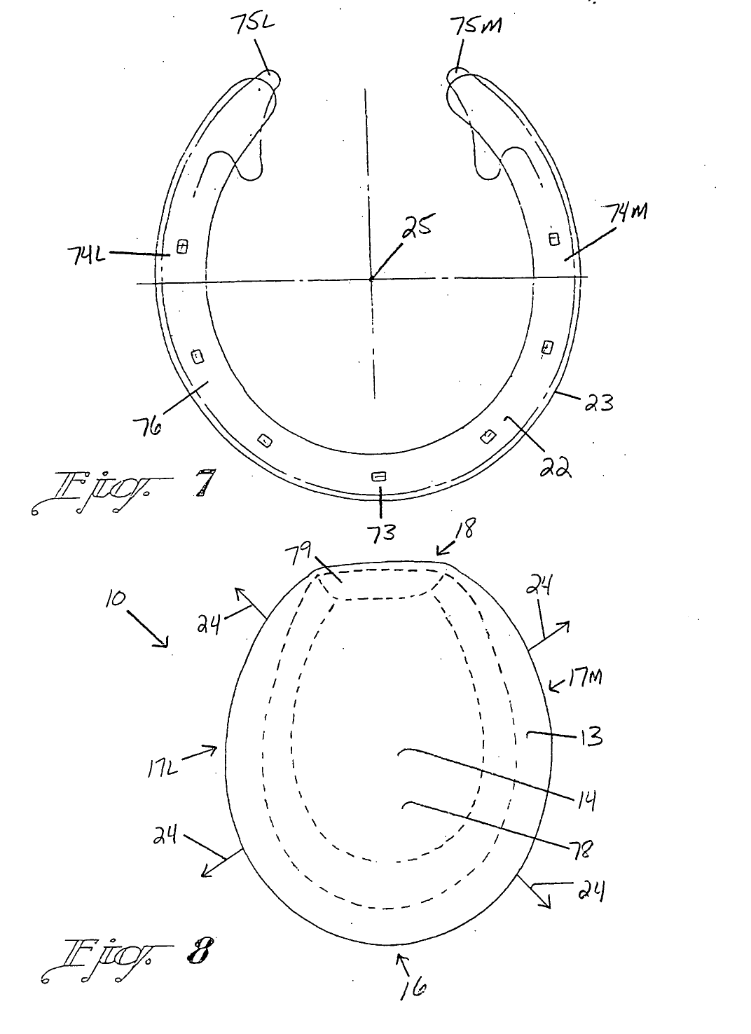

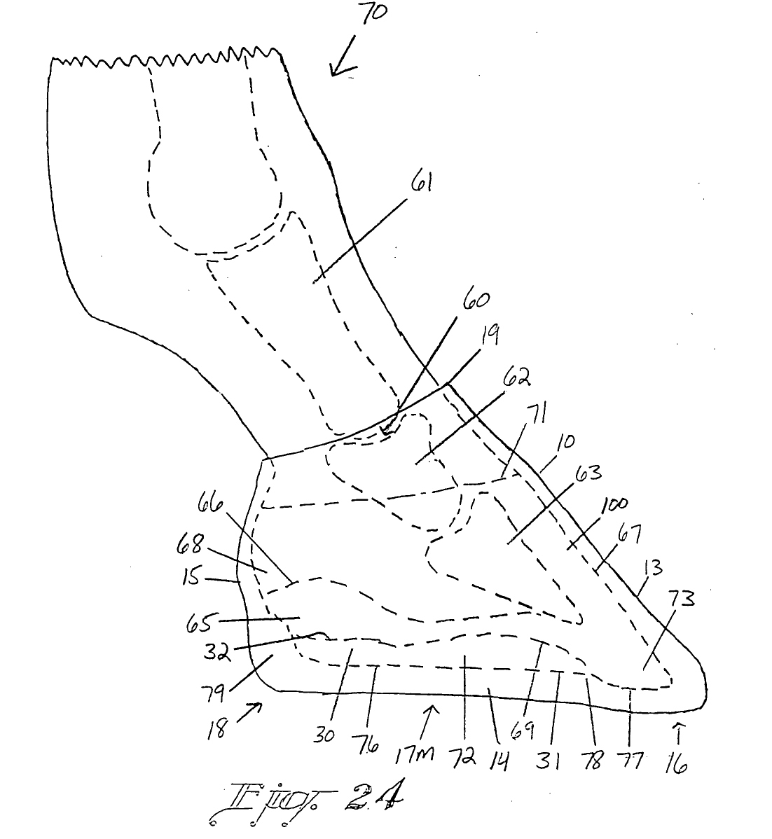

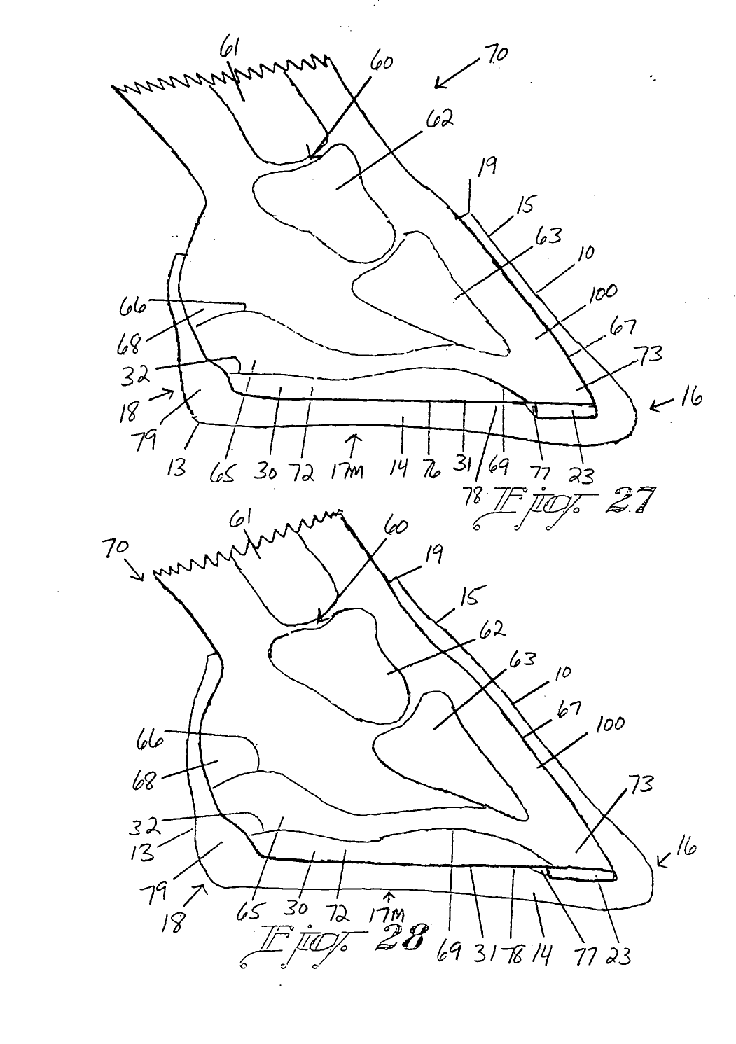

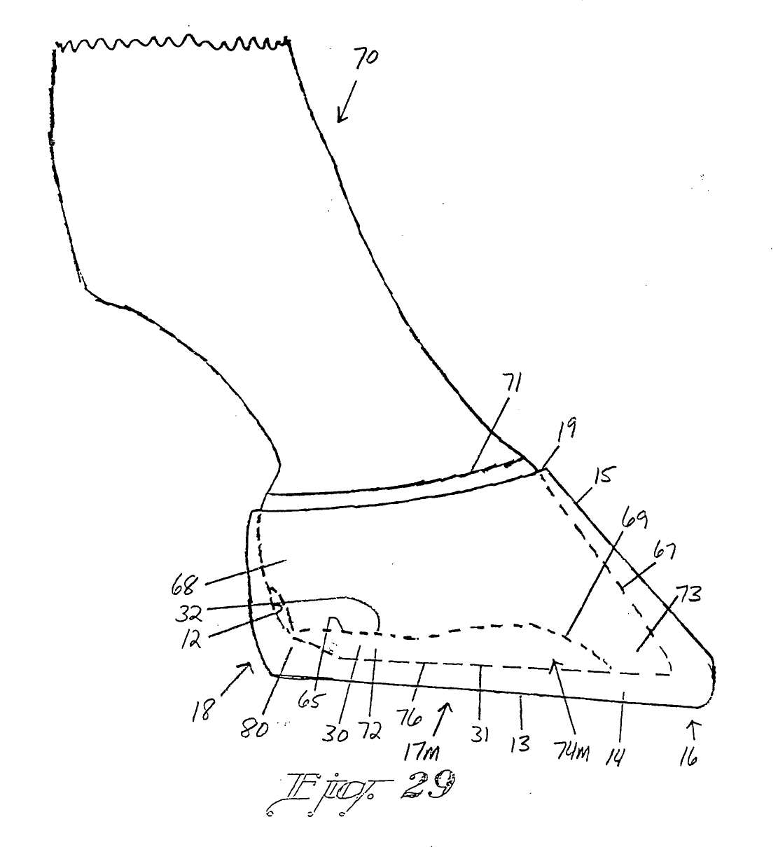

FIGS. 1, 3, 9, 13, 15, and 23-28 generally depict various views of a fore leg hoof 100 as inserted in a fore leg hoof boot 10 of the present invention and FIGS. 5, 8, 13, 14, 17, and 21 generally depict fore leg hoof boot 10 in various views as removed or separated from fore leg hoof 100. FIG. 7 is a bottom plan view of certain distally terminal structures otherwise associated with fore leg hoof 100. FIGS. 2, 4, and 16 generally depict various views of a hind leg hoof 200 as inserted in a hind leg hoof boot 20 of the present invention and FIGS. 6, 14, 18, and 22 generally depict hind leg hoof boot 20 in various views as removed or separated from hind leg hoof 200.

It will be seen from a general inspection of FIG. 14 that hoof boot kit 90 may comprise at least one select, anatomically-specific hoof boot, such as fore leg hoof boot 10 and/or hind leg hoof boot 20; boot or hoof inserts 30; a select topical therapeutic agent or medicament 40; and certain attachment or fastening means (as generally referenced at 50) for attaching or fastening the boot inserts 30 within either fore leg hoof boot 10 or hind leg hoof boot 20. All of the components may then be presented to the end user in an unassembled state in a kit package, such as a box 91 or similar other packaging means.

From a careful inspection of the noted figures, it will be seen that fore leg hoof 100 differs from hind leg hoof 200 primarily in the angles of inclination or obliquity at the anterior portions or regions of the respective hoofs. In this regard, it will be noted that fore leg hoof 100 comprises a first angle of inclination at the anterior region as referenced at 11 in FIG. 1, and hind leg hoof 200 comprises a second angle of inclination at the anterior region as referenced at 21 in FIG. 2. FIGS. 1 and 2 are presented on the same drawing sheet for ease of comparative inspection. It will be seen that second angle of inclination 21 is greater in magnitude than first angle of inclination 11. In other words, hind leg hoofs, such as hind leg hoof 200, are generally less frustoconical and more cylindrical and fore leg hoofs, such as fore leg hoof 100, are generally more frustoconical and less cylindrical. Described yet another way, the hind leg hoof is typically steeper at the anterior wall portion thereof as compared to the anterior wall portion of the fore leg hoof. Thus, it is contemplated that the hoof boot assembly or hoof boot kit 90 of the present invention may comprise at least one select, anatomically-specific hoof boot as selected from the group consisting of at least one fore leg hoof boot 10 and at least one hind leg hoof boot 20.

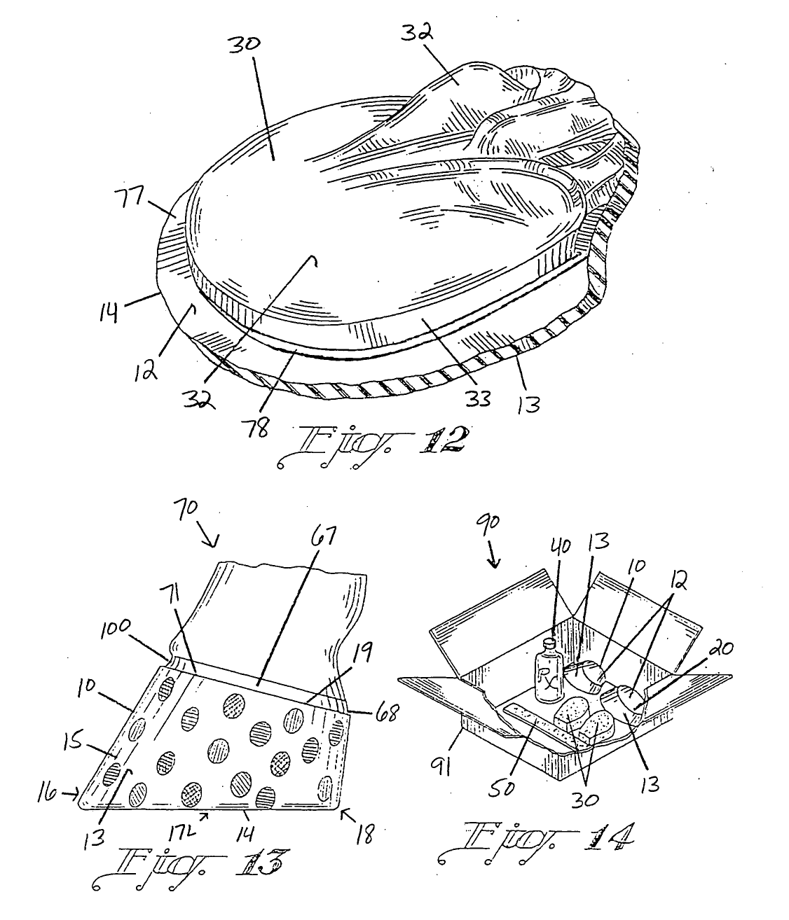

When used as a therapeutic hoof boot assembly for remedying a select equine hoof disorder (such as thrush, abscess, bruise or other tissue trauma, and laminitis), it is contemplated that the therapeutic hoof boot assembly will preferably comprise, in combination, an elastic hoof boot (either fore leg hoof boot 10 or hind leg hoof boot 20); a boot or hoof insert 30 as illustrated and referenced in FIGS. 10, 11, 12, 14, 15, 16-30; and a select medicament 40 as generally depicted in FIGS. 10, 14, and 19 as a bottled or packaged therapeutic treatment agent for treating a select equine hoof disorder. When used as an ornamental hoof boot assembly for ornamentally outfitting an equine's hoof or hooves, it is contemplated that the hoof boot assembly will preferably comprise the hoof boot (either fore leg hoof boot 10 or hind leg hoof boot 20), the outer surface of which may be provided with select coloration for enhancing the appearance of the hoof boot. Other features, such as boot insert 30 and select medicament 40 may be added to the ornamental hoof boot assembly per the election of the user, or as may be required.

It is further contemplated that the elastic hoof boot(s) 10 and 20 are constructed from or comprise a select rubber material, preferably naturally-occurring, vulcanized (and thus thermoset) rubber. It is noted that naturally-occurring rubber is an elastic hydrocarbon polymer which occurs as a milky emulsion (known as latex) in the sap of a number of plants but can also be produced synthetically. Aside from a few natural product impurities, natural rubber is essentially a polymer of isoprene units, a hydrocarbon diene monomer. Synthetic rubber can be made as a polymer of isoprene or various other monomers. At ambient temperatures rubbers are thus relatively soft and deformable, typically having a modulus of elasticity on the order of 1-3 megapascals (MPa).

The modulus of elasticity may be generally defined as the rate of change of strain as a function of stress (i.e. the slope of the straight line portion of a stress-strain diagram). Depending on the type of loading represented by the stress-strain diagram, the modulus of elasticity may be reported as compressive modulus of elasticity (or modulus of elasticity in compression), flexural modulus of elasticity (or modulus of elasticity in flexure), shear modulus of elasticity (or modulus of elasticity in shear), tensile modulus of elasticity (or modulus of elasticity in tension) or torsional modulus of elasticity (or modulus of elasticity in torsion). The term “modulus,” when used alone, generally refers to the tensile modulus of elasticity.

It is contemplated that the select rubber material of the present invention preferably comprises a tensile modulus of elasticity on the order of 1 MPa (naturally-occurring rubber typically having a modulus of elasticity ranging from about 0.3-1.5 MPa given a relatively small strain such as is capable by human hand-delivered forces). Given a modulus of elasticity on the order of 1 MPa, excellent results have been achieved with hoof boot(s) 10 and/or 20 to achieve a number of functions, including, but not limited to (1) selectively outfitting the hoof structure with the hoof boot by manually (under forces originating from or imparted by a human hand) stretching or tensioning the hoof boot to envelope a horse hoof; (2) maintaining hoof boot 10 or 20 in an enveloped relation about the outfitted hoof structure (by providing restorative hugging forces directed toward the longitudinal axis of the hoof structure (as referenced at point 25 in FIGS. 7 and 9); and (3) allowing substantially natural wall expansion and substantially natural wall contraction under a typical or natural equine gait (i.e. the wall of an equine hoof naturally expanding upon hoof engagement with a support surface and the wall of an equine hoof naturally contracting upon hoof disengagement from a support surface).

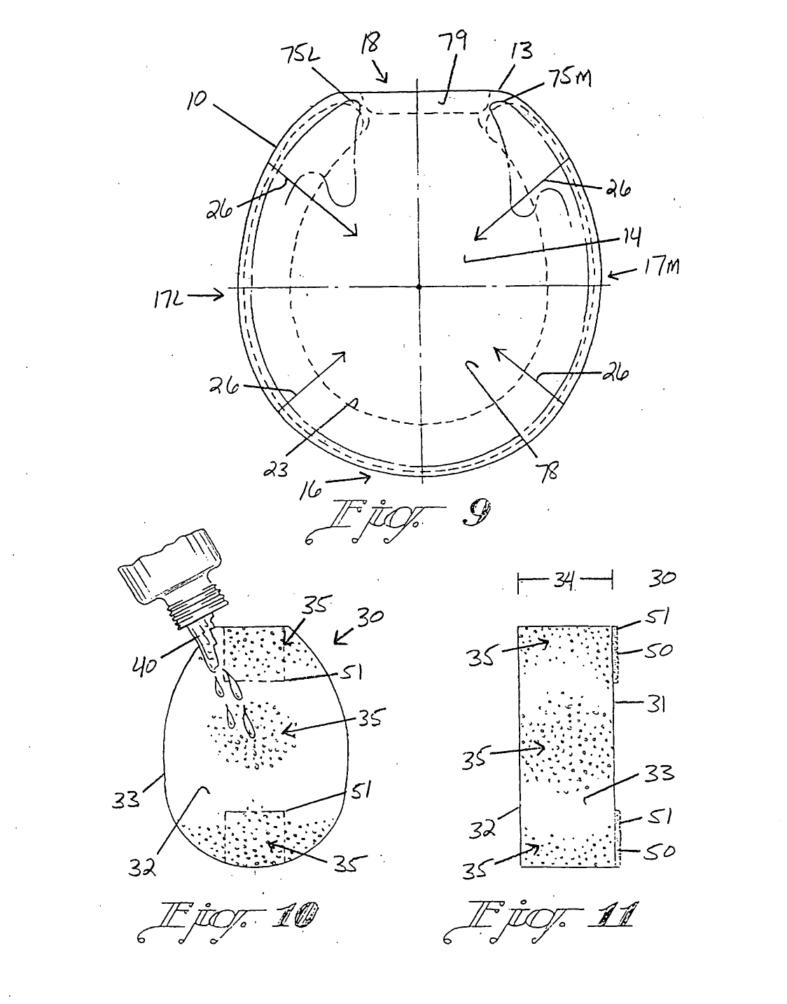

From a consideration of FIGS. 7-9 in tandem, it will be understood that hoof boot(s) 10 and 20 are stretchable or tensionable. As earlier stated, FIG. 7 depicts certain distally terminal structures associated with an equine or horse hoof, such as a distal wall terminus 22 of a horse hoof and a horseshoe 23 as attached to distal wall terminus 22 of the horse hoof generally depicted. Horseshoe 23 is further depicted or referenced in FIGS. 1-4, 9, 15, 16, 25, 27, and 28. FIG. 8 is a bottom plan view of the fore leg hoof boot 10 (as perhaps comparable with the top plan view of the fore leg hoof boot 10 depicted in FIG. 5) in a relaxed (unstretched or untensioned) state. When fore leg hoof boot 10 (or hind leg hoof boot 20) is stretched or tensioned as referenced at vector arrows 24 in FIG. 8, the material stretches under the forces represented by vector arrows 24 to a first outfitting displacement (not specifically depicted) enabling the boot to be placed upon or outfitted upon the hoof structure. Hoof boots 10 or 20 then elastically return to a second outfitting displacement from relaxed equilibrium as generally depicted in FIG. 9, but having restorative hoof-hugging forces 26 directed toward longitudinal axis 25 (as generally depicted in FIG. 9) as a means to maintain hoof boot(s) 10 or 20 in an enveloped relation about the outfitted hoof structure. It is contemplated that a modulus of elasticity on the order of 1 MPa will function to maintain hoof boot(s) in enveloped relation about the hoof structure in most support surface conditions, such as may be experienced under a typical equine gait through fields and the like having mud (having forces opposite in direction, but lesser in magnitude than the hoof-hugging forces 26 at the second outfitting displacement), which may otherwise tend to remove or disengage hoof boot(s) 10 or 20 from the hoof structure.

Additionally, it is contemplated that the wall expansive and wall contractive forces inherent under the typical equine gait as the hoof structure engages and disengages from the support surface will not be adversely affected by hoof-hugging forces 26. In other words, when an equine such as a horse steps upon a support surface, the wall of the hoof structure slightly expands radially outward (under the weight of the equine) and when the equine steps off the support surface, the wall of the hoof structure slightly contracts (or returns to a relaxed equilibrium state). In this regard, it is contemplated that a modulus of elasticity on the order of 1 MPa will allow normal expansion and contraction with negligible forceful interference from hoof-hugging forces 26.

Hoof boot(s) 10 and 20 each further preferably comprise an inner boot surface 12 as illustrated and referenced in FIGS. 3, 5, 6, 12, 14, 17, 18, 21, 22, 25, 26, 29, and 30; an outer boot surface 13 as illustrated and referenced in FIGS. 1-6, 8, 9, 12-18, and 21-30; a distal sole-opposing portion 14 as illustrated and referenced in FIGS. 1-6, 8, 9, 12, 13, 15-18, and 23-30; a proximally-extending, wall-opposing portion 15 as illustrated and referenced in FIGS. 1-6, 13, 15-18, and 21-30; an anterior toe region 16 as illustrated and referenced in FIGS. 1-6, 8, 9, 13, 15-18, and 21-30; a medial quarter region 17M as illustrated and referenced in FIGS. 5, 6, 8, 9, 17, 18, and 21-30; a lateral quarter region 17L as illustrated and referenced in FIGS. 1-6, 8, 9, 13, 17, 18, 21, and 22; and a posterior heel region 18 as illustrated and referenced in FIGS. 1-6, 8, 9, 13, 15-18, and 21-30. It will be understood from an inspection of the noted figures that sole-opposing portion 14 and wall-opposing portion 15 are integrally and continuously formed with one another from the specified select elastic or rubber material and that outer boot surface 13 at sole-opposing portion 14 is substantially planar. Wall-opposing portion 15 further comprises a proximal terminus 19 as further illustrated and referenced in FIGS. 1-6, 13, 15-18, and 21-30. A number of variously sized hoof boot(s) are contemplated for outfitting variously sized equine hooves. In this regard, an appropriate size hoof boot can be chosen by the user bearing in mind that wall-opposing portion 15 and sole-opposing portion 14 should be in a tensioned state to properly maintain the respective hoof boot in enveloped relation about the hoof structure. In this regard, the reader may wish to revisit and comparatively inspect FIGS. 7-9 and the foregoing descriptions pertinent thereto.

It will be seen from a general inspection of the FIGS. 1-4, 15, 16, and 23-30 that wall-opposing portion 15 or the wall-hugging portion comprises a minimal wall portion thickness preferably adjacent proximal terminus 19; a maximal wall portion thickness, preferably adjacent the (integral) junction joining wall-opposing portion 15 to sole-opposing portion 14; and a plurality of infinitesimal incremental wall portion thicknesses extending intermediate the minimal wall portion thickness and the maximal wall portion thickness. In other words, with respect to hoof boot 10, inner boot surface 12 adjacent anterior toe region 16 comprises a generally frustoconically sloped surface to properly accept first angle of inclination 11. Outer boot surface 13 adjacent anterior toe region 16 also comprises a generally frustoconically sloped surface having a third angle of inclination 9 (as measured from the plane 7 in which inner boot surface 12 at sole-opposing portion 14 lies), which third angle of inclination 9 is slightly lesser in magnitude than first angle of inclination 11. Similarly, with respect to hoof boot 20, inner boot surface 12 adjacent anterior toe region 16 comprises a generally frustoconically sloped surface to properly accept second angle of inclination 21. Outer boot surface 13 adjacent anterior toe region 16 also comprises a generally frustoconically sloped surface having a fourth angle of inclination 8 (as measured from the plane 6 in which inner boot surface 12 at sole-opposing portion 14 lies), which fourth angle of inclination 8 is slightly lesser in magnitude than second angle of inclination 21 as generally depicted in FIG. 2. The select elastic or rubber material extending intermediate inner boot surface 12 and outer boot surface 13 adjacent anterior toe region 16 thus comprises a greater thickness (i.e. the maximal wall portion thickness) adjacent sole-opposing portion 14 as compared to the thickness adjacent proximal terminus 19 (i.e. the minimal wall portion thickness). It is thus contemplated that anterior toe region 16 comprises a distal anterior toe region thickness, the distal anterior toe region thickness being substantially equal in magnitude to the maximal sole thickness, which maximal sole thickness is about twice or double the magnitude of the minimal wall portion thickness.

It will be further seen that sole-opposing portion 14 may comprise a plurality of regional sole portion thicknesses, depending on certain structures located at inner boot surface 12 thereof, as described in more detail hereinafter. Notably, however, the regional sole thicknesses comprise a maximal sole thickness, which maximal sole thickness is preferably adjacent anterior toe region 16. It is contemplated that the preferred minimal wall portion thickness has a measured magnitude of about 0.25 inches and the maximal wall portion and the regional sole portion thicknesses are each selected from a thickness range, the thickness range ranging from about 0.25 inches to about 0.50 inches, the maximal thicknesses each being on the order of about 0.50 inches.

Added thickness adjacent the distal anterior toe region is preferred due to the typical equine gait, the hoof striking a support surface during a normal gait; toe first, then heel. The added thickness and inherent compressive modulus of elasticity of the preferred select elastic or rubber material together function to prevent the toe from otherwise severing wall-opposing portion 15 from sole-opposing portion 14. In this regard, it will be noted that naturally-occurring vulcanized rubber has relatively high compression fatigue. Decreased thickness adjacent the proximal terminus 19, on the other hand, results in a more easily donned hoof boot in that thinner materials having the same modulus of elasticity tend to require less (hand-delivered) force to effect a stretch. In this regard, the wall-opposing portion 15 has minimized thickness adjacent proximal terminus 19 so as to enable a user to more easily apply hoof boot(s) 10 or 20 to an equine hoof or to more easily remove hoof boot(s) 10 or 20 from an equine hoof, as generally depicted in FIG. 3 at 95.

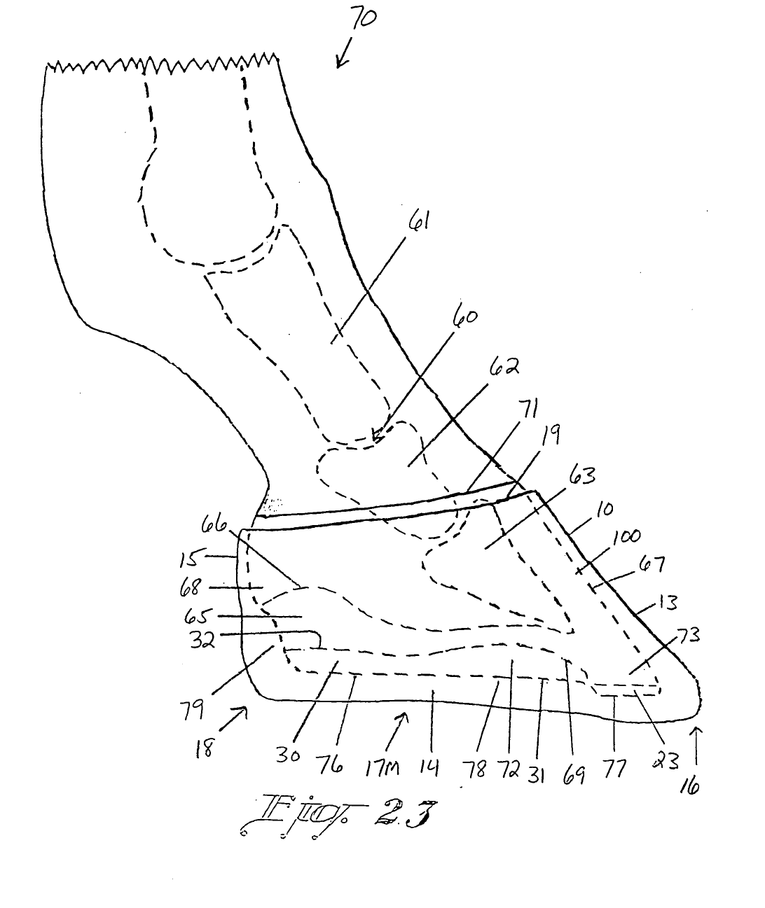

Boot insert 30 may also be thought of as a hoof insert and is preferably constructed from or comprises a select viscoelastic foam such as so-called “memory foam,” the viscoelastic foam or similar other compressive material having interstitial pores 35 as illustrated and referenced in FIGS. 10, 11, and 19-22 for releasably receiving the select medicament 40 as further generally depicted in FIGS. 10 and 19. Boot insert 30 further preferably comprises a distal insert surface 31 as illustrated and referenced in FIGS. 11, 15, 16, 20, 23, 24, and 26-30; a proximal insert surface 32 as illustrated and referenced in FIGS. 10, 11, 15, 16, and 19-30; a peripheral insert surface 33 as illustrated and referenced in FIGS. 10-12, 19, and 20; and a substantially uniform relaxed insert thickness as generally referenced at 34 in FIG. 11. It will be seen that peripheral insert surface 33 extends intermediate the distal insert surface 31 and the proximal insert surface 32, the uniform width of which is equal to the relaxed insert thickness 34. Distal insert surface 31 is removably engageable with inner boot surface 12 at sole-opposing portion 14. In this regard, it is contemplated that the user may wish to removably fasten or attach distal insert surface 31 to inner boot surface 12 via some fastening means. It is thus contemplated that hook and loop fastening means or adhesive attachment means may be utilized to removably fasten or attach distal insert surface 31 to inner boot surface 12. An exemplary hook and loop fastening means is generally depicted in FIGS. 5, 6, 10 and 11 at 51. For example, it is contemplated that VELCRO brand hook and loop fastening structure could be utilized as a fastening means.

The select medicament 40 is incorporated to the design of the hoof boot assembly and/or kit for effectively treating a select equine hoof disorder as previously exemplified. In this regard, it is contemplated that any number of homeopathic treatment solutions (such as a vinegar and water solution) could be releasably received in interstitial pores 35. Further, common brand name solutions and/or agents such as HOOF HEAL brand solution, THRUSH BUSTER brand solution, FORSCHNER'S brand hoof pack agent or similar other hoof pack agents can be releasably received by interstitial pores 35 for topically treating the select equine hoof disorder, as may be required. Additionally, it is noted that certain antibiotics and/or drawing agents may be cooperatively associated with boot insert 30 for treating the select equine hoof disorder, as may be further required. It will be understood that this listing of medicinal products is obviously exemplary as but a short listing of the myriad topical treatment agents and solutions for any number of equine hoof disorders. It will be further understood that interstitial pores 35 and the select medicament 40 together cooperatively function as medicament application means when boot insert 30 undergoes compression by a sole 69 and a frog 65 of a hoof cavity. Thus, certain medicament application means may be defined by interstitial pores 35 and the select medicament 40 as releasably received by interstitial pores 35, the select medicament 40 being releasable from interstitial pores 35 via proximal insert surface 32 for topically treating the select equine hoof disorder.

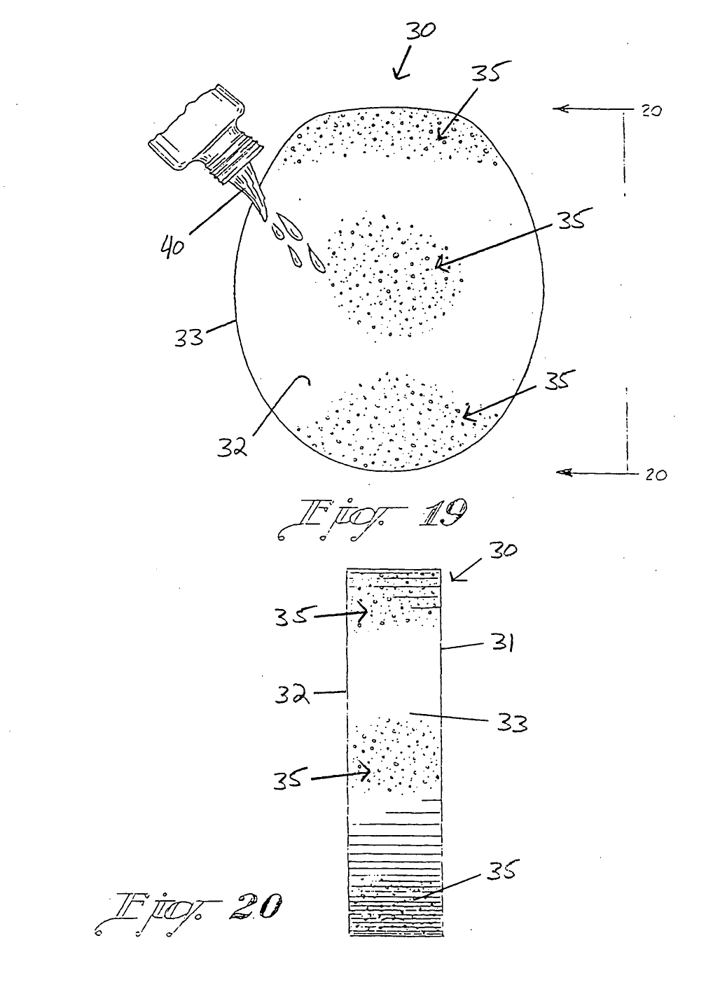

Hoof boot(s) 10 or 20 are attachable to certain distal portions of an equine leg 70 as generally referenced in FIGS. 1-4, 13, 15, 16, and 23-30, which necessarily comprises a pastern joint 60 as referenced in FIGS. 15, 16, 23, 24, 27, and 28 intermediate the proximal phalanx 61 and the middle phalanx 62. The distal portions of an equine leg 70 further typically comprise a distal phalanx 63 as further depicted in FIGS. 15, 16, 23, 24, 27, and 28; and a navicular bone 64 is further depicted in FIGS. 15 and 16. Distal to the distal phalanx 63 and the navicular bone 64 is certain soft tissue known as the frog 65 as generally illustrated and referenced in FIGS. 15, 16, and 23-30 as bounded proximally from various other various tissues of the distal equine leg by a frog corium as referenced at 66 in FIGS. 15, 16, 23, 24, 27, and 28.

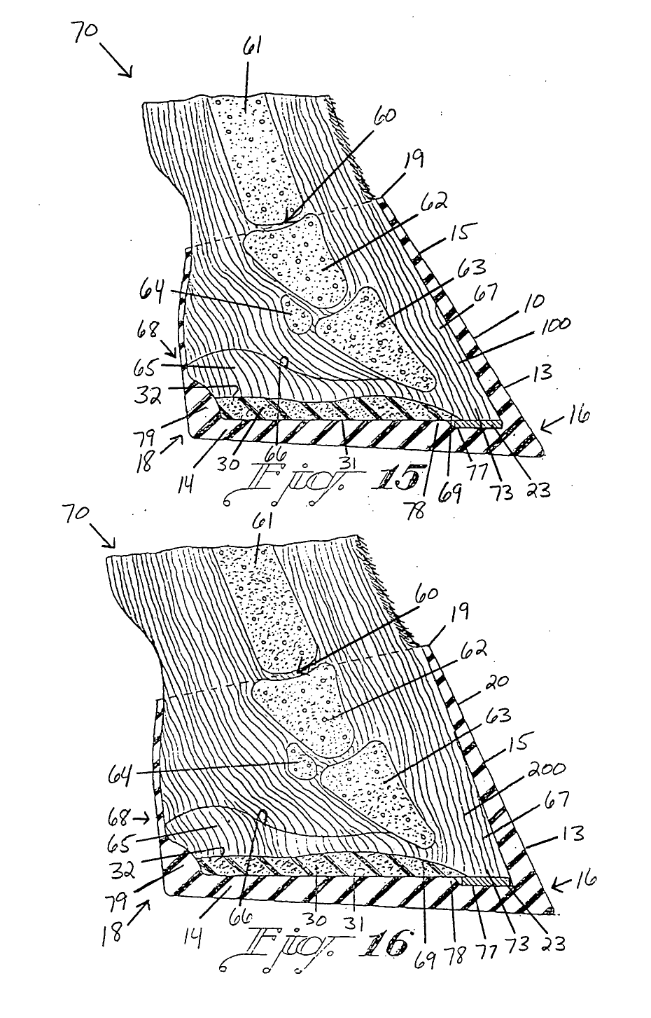

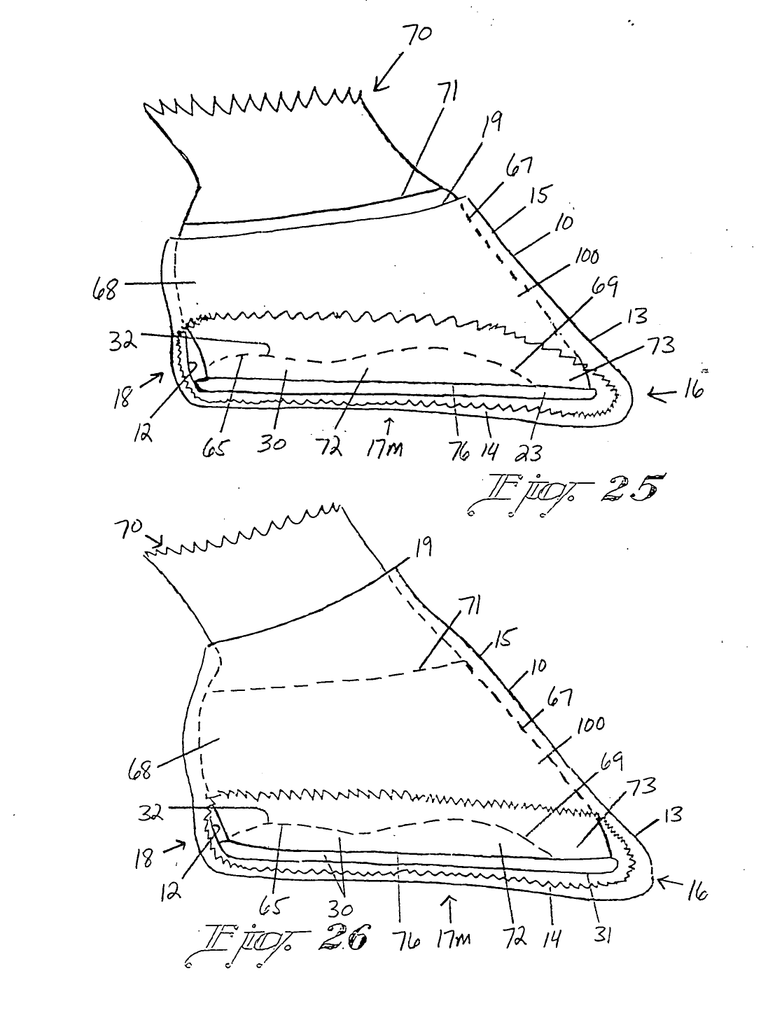

Notably, the distal portion of an equine leg 70 further comprises certain hoof structure (as embodied in either fore leg hoof 100 or hind leg hoof 200), the hoof structure comprising a wall 67 as illustrated and referenced in FIGS. 1-4, 13, 15, 16, and 23-30; a heel 68 as illustrated and referenced in FIGS. 1-4, 13, 15, 16, and 23-30; a sole 69 as illustrated and referenced in FIGS. 15, 16, and 23-30; frog 65 (as previously described); a coronary band 71 as illustrated and referenced in FIGS. 1, 2, 13, 23-26, 29, and 30; and a hoof cavity 72 as generally referenced in FIGS. 23-30. Spatially located in distal adjacency to frog 65 and sole 69, hoof cavity 72 inherently has a varied cavity depth as may be generally understood from an inspection of FIG. 12. It will be recalled from the brief description of drawings section that FIG. 12 is a fragmentary negative impressional perspective view of a hoof cavity as formed upon compressible boot insert 30 or compressibly form-fit boot insert 30. It will thus be understood that hoof cavity 72 has a varied landscape and thus necessarily comprises some maximal cavity depth, typically at the frog 65.

In anatomical terms, sole 69 is a thick plate of horn which, in conjunction with the bars 75L and 75M and frog 65, forms the floor of the hoof. In shape it is irregularly crescentic, the posterior portion of which (that portion between the horns of the crescent), being deeply indented in a V-shaped manner to receive frog 65. Its upper surface is convex, its lower concave. The highest point of superior or internal face of hoof cavity 72 is at the point of its V-shaped indentation. From this point it slopes in every direction downwards and outwards until near the circumference. The whole of the superior face of the sole is covered with numerous fine punctures which receive the papillæ of the sensitive sole. The frog of the hoof is triangular or pyramidal in shape and bears a close resemblance to the form of the plantar cushion, upon the lower surface of which body it is molded.

The wall 67 is essentially that portion of the hoof seen in front and laterally when the equine's foot is on a support surface. Posteriorly, instead of being continued round the heels to complete the circle, its extremities become suddenly inflected downwards, forwards, and inwards. These inflections can only be seen with the foot lifted from the support surface, and form the so-called “bars”. Notably, the wall projects beyond the level of the other structures of the plantar surface, taking upon itself the bearing of the greatest part of the equine's weight. The horn of the wall, viewed immediately from the front, is known as the “toe”, and the remainder of the external face of the wall, that running back to the heels, is typically designated as the “quarters”. As earlier stated, in the middle region of the toe, the wall following the angle of the bones is more or less oblique depending on whether the hoof extends from a fore leg or a hind leg. The general obliquity in either case decreases as the quarters are reached, until on reaching the heels the wall is nearly upright.

Inner boot surface 12 of hoof boot(s) 10 and 20 may further preferably comprise select anatomy-conforming, boot-positioning means for aligning the hoof boot assembly relative to the hoof structure. In this regard, it is contemplated that certain contours or structures may be incorporated into inner boot surface 12 as a means to properly position hoof boot(s) 10 and 20 relative to the respective hoof structure, bearing in mind that hoof boot 10 is provided for attachment to fore leg hoof 100 and hoof boot 20 is provided for attachment to hind leg hoof 200. The anatomy-conforming, boot-positioning means may thus be defined by the varied angles of inclination at the anterior regions of each hoof boot 10 or 20 as appropriate for the type of hoof (fore or hind) being adorned.

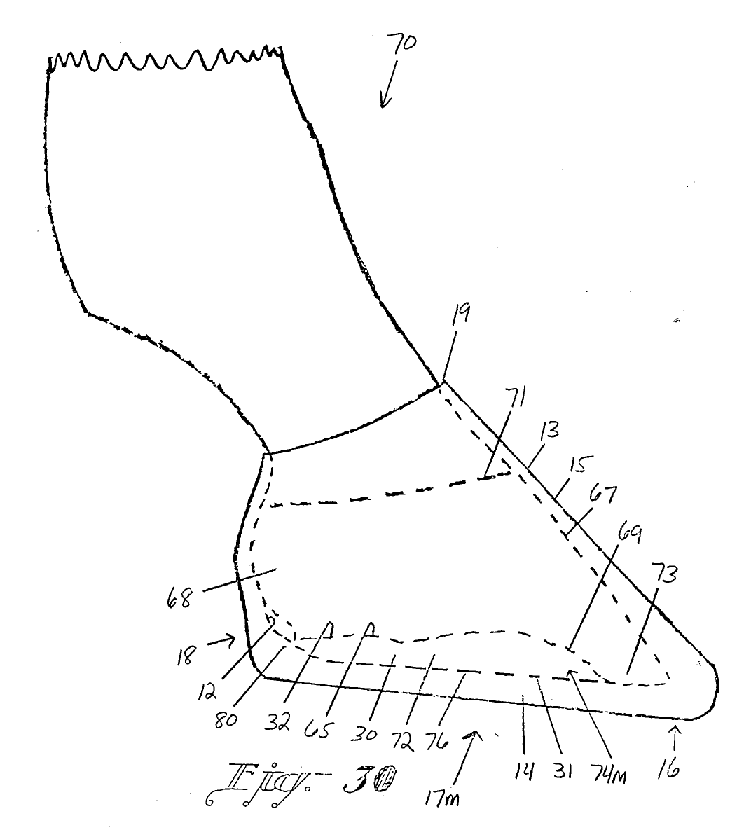

Further, however, it is contemplated that the anatomy-conforming, boot-positioning means may also be selectively defined by the group consisting of inferior hoof-positioning structure and posterior hoof-positioning structure. The inferior hoof-positioning structure may preferably be defined by a peripheral wall-opposing groove 77 as illustrated and referenced in FIGS. 5, 6, 12, 15, 16, 23, 24, 27, and 28; and an insert-receiving plateau 78 or a cavity-opposing portion as illustrated and referenced in FIGS. 5, 6, 8, 9, 12, 15, 16, 23, 24, 27, and 28. It will be seen from a comparative inspection of FIGS. 23/24 versus FIGS. 29/30 that peripheral wall-opposing groove 77 does appear in FIGS. 23 and 24, but does not appear in FIGS. 29 and 30. FIGS. 29 and 30 depict a planar inner boot surface 12 at sole-opposing portion 14 and thus it is believed that peripheral wall-opposing groove 77 may be incorporated as an added feature as a means to position or locate inferior structure of the outfitted hoof, such as horseshoe 23 as may be seen from an inspection of FIGS. 1-4, 15, 16, 25, 27, and 28, or distal wall terminus 76 as may be seen from an inspection of FIG. 24. In this regard, it will be understood that if the hoof structure is shod with a shoe, the shoe is necessarily attached to and substantially concentric with distal wall terminus 76. The shoe is thus receivable either in wall-opposing groove 77 or otherwise intermediate inner boot surface 12 and distal wall terminus 76.

It will be further understood from a consideration of the noted figures that peripheral wall-opposing groove 77 extends anteriorly from posterior heel region 18 along medial quarter region 17M and lateral quarter region 17L to anterior toe region 16. Further, it will be understood that insert-receiving plateau 78 extends anteriorly from posterior heel region 18 intermediate peripheral wall-opposing groove 77. The distal insert surface 31 may thus be removably engageable with insert-receiving plateau 78 and boot insert 30 may be sized and shaped to rest upon insert-receiving plateau 78 such that the peripheral edges thereof are co-curviplanar as generally depicted in FIG. 12 or, alternatively, boot insert 30 may be sized and shaped to rest upon both insert-receiving plateau 78 and peripheral wall-opposing groove 77 (not specifically illustrated). Further, however, if inner boot surface 12 at sole-opposing portion 14 is preferably constructed as a substantially planar surface, then it will be seen that boot insert 30 may rest upon inner boot surface 12 at sole-opposing portion 14 as generally depicted in FIGS. 20, 22, and 26.

Wall 67 inherently has or comprises a toe 73 as illustrated and referenced in FIGS. 1-4, 7, 15, 16, and 23-30; a medial quarter 74M as illustrated and referenced in FIGS. 7, 29, and 30; a lateral quarter 74L as illustrated and referenced in FIG. 7; a medial bar 75M and a lateral bar 75L both as illustrated and referenced in FIGS. 7 and 9; and a distal wall terminus 76 as generally illustrated and referenced in FIGS. 7, and 23-30. As outfitted upon a hoof structure, wall-opposing groove 77 is received in distal adjacency to distal wall terminus 76 at the toe 73 and medial quarter 74M and lateral quarter 74L for properly positioning sole-opposing portion 14 relative to distal wall terminus 76.

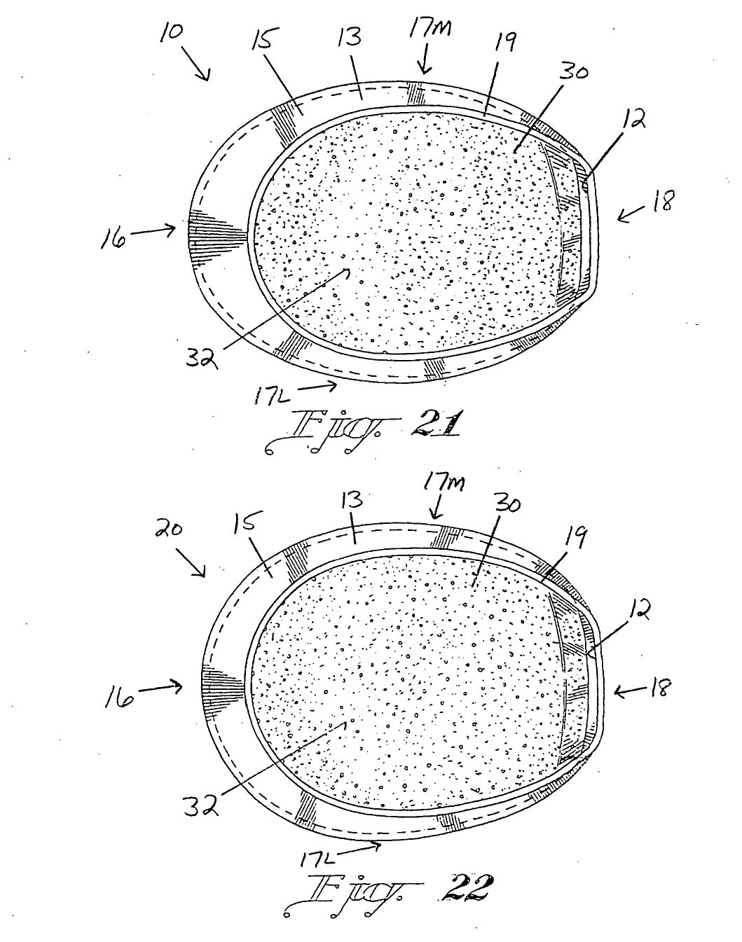

The posterior hoof-positioning structure may preferably be defined by a bar-locating protrusion 79 at posterior heel region 18 as illustrated and referenced in FIGS. 1-6, 8, 9, 15, 16, 23, and 24, or a bar-locating elevation 80 as illustrated and referenced in FIGS. 17, 18, 29, and 30. Both bar-locating protrusion 79 and bar-locating elevation 80 are receivable intermediate medial and lateral bars 75M and 75L for properly positioning posterior heel region 18 relative to heel 68 as may be seen from a visual consideration of FIG. 9. Notably, bar-locating elevation 80 may be defined as a type of bar-locating protrusion for purposes of brevity.

As preliminarily described hereinabove, wall-opposing portion 15 and sole-opposing portion 14 are elastically stretched or tensioned to snugly envelope or hug wall 67 and heel 68. As outfitted upon the hoof structure, proximal terminus 19 is spatially located in selective adjacency to coronary band 71 for preventing coronary band irritation or disruption. In this regard, it is noted that relatively rigid materials, if in continued contact with coronary band 71, will irritate or otherwise disrupt the band from which the wall of the hoof grows. An irritated or otherwise disrupted coronary band with thus delay hoof treatment or cause other band-related hoof disorder(s). In this regard, it is noted that common, off-the-shelf hoof boots for the treatment of hoof disorders are typically made from relatively rigid materials (as compared to naturally-occurring rubber of the type herein preferably specified) and thus are difficult to outfit upon a horse, and once outfitted often cause coronary band disruption.

For purposes of clarity, a human analogy can perhaps be made to relatively soft, pliable latex gloves as compared to relatively coarse, rigid canvas gloves. The softer, more pliable latex gloves are less likely to cause cuticle disruption when donned by a user as compared to coarser, more rigid canvas gloves when donned by a user, particularly when the gloves are in continuous rubbing contact with the cuticle(s). With regard to equines, it has been noted that when a horse develops an abscess on its hoof, a common cure for the same is to soak the hoof in a hoof boot designed to pool a treatment solution in adjacency to the abscess. However, state of the art hoof boots, such as EZ boots, distributed, for example, by Equine Performance Products, 4181 Spring Court, Pilot Hill, Calif., 95664 or the DAVIS boot, manufactured by Davis Manufacturing, Inc., 350 North Center Street, Brandon, Wis., 53919 are not only awkward to outfit upon an equine hoof, but often function in an effective manner, and many times can lead to additional hoof disorder(s). Secondary infections of the coronary band, for example, are common when state of the art hoof boots, such as those here mentioned, are utilized to otherwise remedy primary hoof disorders.

Thus, a key feature of the present invention is to locate proximal terminus 19 in selective adjacency to coronary band 71 so as to prevent coronary band disruption. In this regard, it is contemplated that proximal terminus 19 is spatially located in selective adjacency to coronary band 71 as selected from a spatial grouping, the spatial grouping consisting of a distally adjacent proximal terminus 19 as illustrated and referenced in FIGS. 2, 4, 13, 23, 25, 27, and 29; and a proximally adjacent proximal terminus 19 as illustrated and referenced in FIGS. 1, 3, 15, 16, 24, 26, 28, and 30. The distally adjacent proximal terminus 19 is spatially located in distal adjacency to coronary band 71 so as to prevent any contact with coronary band 71 and thus prevent disruption thereof.

The proximally adjacent proximal terminus 19 is spatially located in superficial adjacency to pastern joint 60 as specifically depicted in anatomical FIGS. 15, 16, 24, and 28. In this last regard, it is contemplated that certain hoof disorders, such as an abscess, when occurring on an otherwise deformed hoof structure, may require additional hoof-hugging forces 26 covering a greater surface area of the distal portions of an equine leg so as to prevent hoof boot(s) 10 and/or 20 from becoming disengaged from the hoof structure. Thus, wall-engaging portion 15 or the wall-hugging portion will likely be in contact with coronary band 71. However, it will be recalled that hoof boot(s) 10 and 20 are preferably constructed from a select rubber or elastic material having certain properties and it is these very same properties that make coronary band disruption unlikely when a proximally adjacent proximal terminus 19 is selected.

It should be further noted that the preferred anatomical spatial location of proximally adjacent proximal terminus 19 is in superficial adjacency to pastern joint 60. In this regard, it is contemplated that distal equine leg irritation is minimized if proximally adjacent proximal terminus 19 is so situated since joint flexure occurs at pastern joint 60. Locating proximally adjacent proximal terminus 19 in superficial adjacency to pastern joint 60 thus minimizes bodily contact (and thus irritation) with the respective terminus.

It will be further noted that the select rubber material or select elastic material used in the construction of hoof boot(s) 10 and 20 is trimmable by any number of cutting implements, such as a scissors or knife. Given a trimmable material, it is further contemplated that outer boot surface 13 at wall-opposing portion 15 or the wall-hugging portion may comprise a plurality of substantially concentric score indicia 81 as generally illustrated and referenced in FIGS. 1 and 2. Score indicia 81 may preferably be provided upon outer boot surface 13 at wall-opposing portion 15 as a means to trim hoof boot(s) 10 and 20 so as to more properly fit hoof structures of varying sizes and properly locate proximal terminus 19. This notion is particularly important in terms of the hoof boot kit 90 here contemplated. In other words, it is contemplated that hoof boot kit 90 may comprise at least one anatomically-specific hoof boot, each of which would necessarily comprise a proximally adjacent proximal terminus 19 with score indicia 81 so that the user may tailor the anatomically-specific hoof boot according to size and shape of the target hoof structure. For example, it is contemplated that if the user were to obtain hoof boot 10 as depicted in FIG. 1, he or she could trim hoof boot 10 at score indicia 81P to more properly locate proximal terminus in superficial adjacency to pastern joint 60. Alternatively, the user could trim hoof boot 10 at score indicia 81D to more properly locate proximal terminus in distal adjacency to coronary band 71. It will thus be understood that the trimmable select rubber material and score indicia 81 together cooperatively enable the user to selectively locate proximal terminus 19.

As briefly described hereinabove, Outer boot surface 13 may additionally comprise select coloration as a means to ornament the therapeutic hoof boot assembly or as a means to simply provide an ornamental hoof boot assembly. In this regard, the reader is specifically directed to FIG. 13, which depicts a multi-colored polka dot scheme as a means to enhance the visual appearance of the hoof boot assembly and thus the equine to passersby or other onlookers. Although not specifically illustrated, it is further contemplated that outer boot surface 13 intermediate score indicia 81 may be color-coded for enhancing the user's ability to properly spatially locate proximal terminus 19 or for further enhancing the visual appearance of the hoof boot assembly (e.g. by incorporating patriotic red, white, and blue stripes and the like).

The maximal cavity depth as earlier specified is preferably lesser in magnitude than insert thickness 34, which thickness is preferably on the order of 2 inches. In this regard, it is noted that the maximal cavity depth of most equines will never exceed 2 inches and thus an insert thickness of 2 inches will operate to provide adequate hoof cavity filling means as generally depicted in FIG. 12. In other words, proximal insert surface 32 is compressible by sole 69 and frog 65, thereby being form-fit to sole 69 and frog 65. As proximal insert surface 32 is compressed in said manner, the select medicament 40 is released from interstitial pores 35 for topically treating the select equine hoof disorder. Thus, proximal insert surface 32 is compressibly form-fit to sole 69 and frog 65 for dynamically eliminating empty space between inner boot surface 12 and sole 69 and frog 65 and for dynamically cushion-shielding sole 69 and frog 65. In other words, the hoof cavity filling means as taught or defined by boot insert 30 or the hoof insert functions to provide a cushion and a shield against harmful debris and the like for sole 69 and frog 65 while simultaneously eliminating empty space between inner boot surface 12 and sole 69 and frog 65 and delivering a topical treatment (medicament 40) to the target hoof area.

It will be recalled that the wall expansive and wall contractive forces inherent under a typical equine gait (as the hoof structure engages and disengages from a support surface) will not be adversely affected the hoof-hugging forces 26. For example, when a horse steps upon a support surface, the wall of the hoof structure slightly expands radially outward (under the weight of the horse) and when the horse steps off the support surface, the wall of the hoof structure slightly contracts (or returns to a relaxed equilibrium state). In this regard, it is contemplated that a modulus of elasticity on the order of 1 MPa will allow normal wall expansion and wall contraction with negligible forceful interference from hoof-hugging forces 26. Additionally, it will be recalled that boot insert 30 is form-fittable to hoof cavity 72.

Bearing these specifications in mind, it should be further noted that the hoof structure, under normal circumstances, is a dynamically developing structure, much like a fingernail on the human hand. In this regard, it is recognized that certain portions of the wall 67 require trimming, usually by a farrier, every four to six weeks. Further, certain areas of the frog and sole may undergo dynamic changes, often also requiring periodic trimming. In this regard, it is further contemplated that hoof boot(s) 10 and/or 20 and boot insert 30 are dynamically engagable with the dynamically developing hoof structure. In other words, the dynamically engagable hoof boot(s) 10 or 20 and boot insert 30 are dynamically conformable to the dynamically developing hoof structure or growth-conformable to the dynamically developing hoof structure. In other words, as certain structures dynamically develop, the hoof boot(s) 10 or 20 and boot insert 30 undergo dynamic deformations to accept the hoof developments.

It will be further understood that an inherent feature of the present invention is a novel method for treating the select equine hoof disorder, as taught by certain elements of the hoof boot assembly, as hereinabove described. In this regard, it is contemplated that the method(s) of the present essentially comprise a first step of providing hoof cavity filling means (such as boot insert 30), a select medicament (such as select medicament 40), and fill retainment means (such as hoof boot(s) 10 or 20). It will be understood that the hoof cavity filling means are designed for releasably retaining the select medicament, for dynamically eliminating empty space within a hoof cavity, and for dynamically cushion-shielding a sole and a frog. The second step necessarily involves applying the select medicament to the hoof cavity filling means, the hoof cavity filling means releasably retaining the select medicament. Next, the user must fill the hoof cavity with the hoof cavity filling means, the select medicament being releasable thereby for treating a select equine hoof disorder. Then, the fill retainment means may selectively retain the hoof cavity filling means and select medicament in the hoof cavity for treating the select equine hoof disorder. In other words, the user may periodically don the hoof boot and remove the hoof boot as may be required for periodic hoof status inquires or check-ups.

Notably, the hoof cavity filling means may be defined by hoof insert 30 and the fill retainment means may be defined by either hoof boot 10 or hoof boot 20. It will be recalled that hoof cavity 72 has a maximal cavity depth. Hoof insert 30 comprises proximal insert surface 32 and relaxed insert thickness 34. The maximal cavity depth is lesser in magnitude than relaxed insert thickness 34 and thus when proximal insert surface 32 is compressibly form-fit to sole 69 and frog 65, hoof insert 30 dynamically eliminates empty space between inner boot surface 12 and sole 69 and frog 65 and further dynamically cushion-shields sole 69 and frog 65 substantially as earlier specified.

While the above description contains much specificity, this specificity should not be construed as limitations on the scope of the invention, but rather as an exemplification of the invention. For example, as is described hereinabove, it is contemplated that the present invention essentially discloses a hoof boot assembly for either therapeutically treating a select equine hoof disorder or for ornamentally outfitting a hoof structure, or both, which assembly(ies) may be provided in an unassembled state in the form of a kit for enabling end users to apply the boot or other features as needed or desired by the end user. Accordingly, although the invention has been described by reference to a preferred embodiment, it is not intended that the novel kit be limited thereby, but that modifications thereof are intended to be included as falling within the broad scope and spirit of the foregoing disclosure, the following claims and the appended drawings.

1. A therapeutic hoofboot assembly for remedying a select equine hoof disorder, the therapeutic hoof boot assembly comprising, in combination:
an elastic hoof boot, the hoof boot comprising select rubber material, an inner boot surface, an outer boot surface, a distal sole-opposing portion, a proximally-extending, wall-opposing portion, an anterior toe region, a medial quarter region, a lateral quarter region, and a posterior heel region, the sole-opposing and wall-opposing portions being integrally and continuously formed with one another, the wall-opposing portion comprising a proximal terminus;
a boot insert, the boot insert comprising a select viscoelastic foam, a distal insert surface, a proximal insert surface, and a substantially uniform relaxed insert thickness, the select viscoelastic foam comprising interstitial pores, the distal insert surface being removably engageable with the inner boot surface at the sole-opposing portion; and
a medicament, the medicament for effectively treating a select equine hoof disorder, the medicament being releasably received in the interstitial pores, the hoof boot being attachable to an equine leg, the equine leg comprising a pastern joint and a hoof structure, the hoof structure comprising a wall, a heel, a sole, a frog, a coronary band, and a hoof cavity, the hoof cavity comprising a maximal cavity depth, the wall comprising a toe, medial and lateral quarters, medial and lateral bars, and a distal wall terminus, the wall-opposing and sole-opposing portions being elastically tensioned to snugly envelope the wall and the heel, the proximal terminus being located in selective adjacency to the coronary band for preventing coronary band irritation, the maximal cavity depth being lesser in magnitude than the insert thickness, the proximal insert surface being compressibly form-fit to the sole and the frog, the medicament being releasable from the interstitial pores via the compressible form-fit proximal insert surface for topically treating the select equine hoof disorder.

2. The therapeutic hoof boot assembly of claim 1 wherein the inner boot surface comprises select anatomy-conforming, boot-positioning means, the select anatomy-conforming, boot-positioning means for aligning the hoof boot relative to the hoof structure.

3. The therapeutic hoof boot assembly of claim 2 wherein the select anatomy-conforming, boot-positioning means are selectively defined by the group consisting of inferior hoof-positioning structure and posterior hoof-positioning structure, the inferior hoof-positioning structure being defined by a peripheral wall-opposing groove and an insert-receiving plateau at the sole-opposing portion, the wall-opposing groove extending anteriorly from the posterior heel region along the medial and lateral quarter regions to the anterior toe region, the insert-receiving plateau extending anteriorly from the posterior heel region intermediate the wall-opposing groove, the distal insert surface being removably engageable with the insert-receiving plateau, the wall-opposing groove being received in distal adjacency to the distal wall terminus al the toe and medial and lateral quarters for properly positioning the sole-opposing portion relative to the distal wall terminus, the posterior hoof-positioning structure being defined by a bar-locating protrusion at the posterior heel region, the bar-locating protrusion being receivable intermediate the medial and lateral bars for properly positioning the posterior heel region relative to the heel.

4. The therapeutic hoof boot assembly of claim 1 wherein the select rubber material comprises a tensile modulus of elasticity, the tensile modulus of elasticity being on the order of 1 MPa, the tensile modulus of elasticity for enabling a user to selectively outfit the hoof structure with the hoof boot, for maintaining the hoof boot in enveloped relation about the hoof structure, and for allowing substantially natural wall expansion and wall contraction.

5. The therapeutic hoof boot assembly of claim 1 wherein the proximal terminus is located in selective adjacency to the coronary band as selected from a spatial grouping, the spatial grouping consisting of a distally adjacent proximal terminus and a proximally adjacent proximal terminus, the distally adjacent proximal terminus being spatially located in distal adjacency to the coronary band, the proximally adjacent proximal terminus being spatially located in superficial adjacency to the pastern joint.

6. The therapeutic hoof boot assembly of claim 5 wherein the select rubber material is trimmable and outer boot surface at the wall-opposing portion comprises a plurality of substantially concentric score indicia, the trimmable select rubber material and the score indicia cooperatively enabling the user to selectively locate the proximal terminus.

7. The therapeutic hoof boot assembly of claim 1 wherein the hoof structure dynamically develops, the hoof boot and the boot insert being dynamically engagable with the dynamically developing hoof structure, the dynamically engagable hoof boot and boot insert being dynamically conformable to the dynamically developing hoof structure.

8. The therapeutic hoof boot assembly of claim 1 wherein the hoof structure is shod with a shoe, the shoe being attached to and substantially concentric with the distal wall terminus, the shoe being receivable intermediate the inner boot surface and the distal wall terminus.

9. The therapeutic hoof boot assembly of claim 1 wherein the outer boot surface comprises select coloration, the select coloration for ornamenting the therapeutic hoof boot assembly.

10. The therapeutic hoof boot assembly of claim 1 wherein the wall-opposing portion comprises a minimal wall portion thickness, a maximal wall portion thickness, and a plurality of infinitesimal incremental wall portion thicknesses extending intermediate the minimal wall portion thickness and the maximal wall portion thickness, the sole-opposing portion comprising a plurality of regional sole portion thicknesses, the regional sole thicknesses comprising a maximal sole thickness.

11. The therapeutic hoof boot assembly of claim 10 wherein the anterior toe region comprises a distal anterior toe region thickness, the distal anterior toe region thickness being substantially equal in magnitude to the maximal sole thickness, the maximal sole thickness being about twice the minimal wall portion thickness.

12. The therapeutic hoof boot assembly of claim 11 wherein the minimal wall portion thickness has a measured magnitude of about 0.25 inches and the maximal wall portion thickness and the regional sole portion thickness are each selected from a thickness range, the thickness range ranging from about 0.25 inches to about 0.50 inches.

13. A hoof boot assembly for ornamentally outfitting a hoof structure, the hoof boot assembly comprising a hoof boot, the hoof boot comprising select elastic material, an inner boot surface, an outer boot surface, a distal sole-opposing portion, a proximally-extending, wall-hugging portion, an anterior toe region, a medial quarter region, a lateral quarter region, and a posterior heel region, the wall-hugging portion comprising a proximal terminus, the outer boot surface comprising select coloration, the select coloration for ornamenting the hoof boot assembly, the hoof boot being attachable to an equine leg, the equine leg comprising a pastern joint and a hoof structure, the hoof structure comprising a wall, a heel, a sole, a frog, and a coronary band, the wall comprising a toe, medial and lateral quarters, medial and lateral bars, and a distal wall terminus, the sole-opposing and wall-hugging portions being elastically tensioned to snugly envelope the wall and the heel, the proximal terminus being spatially located in selective adjacency to the coronary band for preventing coronary band disruption.

14. The hoof boot assembly of claim 13 wherein the inner boot surface comprises select anatomy-conforming, boot-positioning means, the select anatomy-conforming, boot-positioning means for aligning the hoof boot assembly relative to the hoof structure.

15. The hoof boot assembly of claim 14 wherein the select anatomy-conforming, boot-positioning means are selectively defined by the group consisting of inferior hoof-positioning structure and posterior hoof-positioning structure, the inferior hoof-positioning structure being defined by a peripheral wall-opposing groove and a cavity-opposing portion at the sole-opposing portion, the wall-opposing groove extending anteriorly from the posterior heel region along the medial and lateral quarter regions to the anterior toe region, the cavity-opposing portion extending anteriorly from the posterior heel region intermediate the wall-opposing groove, the wall-opposing groove being received in distal adjacency to the distal wall terminus at the toe and medial and lateral quarters for properly positioning the sole-opposing portion relative to the distal wall terminus, the posterior hoof-positioning structure being defined by a bar-locating protrusion at the posterior heel region, the bar-locating protrusion being receivable intermediate the medial and lateral bars for properly positioning the posterior heel region relative to the heel.

16. The hoof boot assembly of claim 13 wherein the select elastic material comprises a tensile modulus of elasticity, the tensile modulus of elasticity being on the order of 1 MPa, the tensile modulus of elasticity for enabling a user to selectively outfit the hoof structure with the hoof boot, for maintaining the hoof boot in enveloped relation about the hoof structure, and for allowing wall expansion and wall contraction.

17. The hoof boot assembly of claim 13 wherein the proximal terminus is located in selective adjacency to the coronary band as selected from a spatial grouping, the spatial grouping consisting of a distally adjacent proximal terminus and a proximally adjacent proximal terminus, the distally adjacent proximal terminus being spatially located in distal adjacency to the coronary band, the proximally adjacent proximal terminus being spatially located in superficial adjacency to the pastern joint.

18. The hoof boot assembly of claim 13 wherein the select elastic material is trimmable and the outer boot surface at the wall-opposing portion comprises a plurality of substantially concentric score indicia, the trimmable select elastic material and the score indicia for cooperatively enabling the user to selectively locate the proximal terminus.

19. The hoof boot assembly of claim 13 comprising cavity filling means, the cavity filling means being removably engageably with the inner boot surface at the sole-opposing portion, the cavity filling means being form-fit to the sole and the frog for dynamically eliminating empty space between the inner boot surface and the sole and the frog and for dynamically cushion-shielding the sole and the frog.

20. The hoof boot assembly of claim 19 wherein the cavity filling means is defined by a boot insert and the hoof structure has a hoof cavity, the hoof cavity having a maximal cavity depth, the boot insert comprising an distal insert surface, a proximal insert surface, and a relaxed insert thickness, the distal insert surface being removably engageable with the cavity-opposing portion, the maximal cavity depth being lesser in magnitude than the relaxed insert thickness, the proximal insert surface being compressibly form-fit to the sole and the frog.

21. The hoof boot assembly of claim 20 wherein the boot insert comprises select viscoelastic foam material.

22. The hoof boot assembly of claim 21 wherein the viscoelastic foam material comprises medicament application means, the medicament application means for remedying a select equine hoof disorder.

23. The hoof boot assembly of claim 22 wherein the viscoelastic foam material comprises interstitial pores, the medicament application means being defined by the interstitial pores and a select medicament releasably received by the interstitial pores, the select medicament being releasable from the interstitial pores via the compressible form-fit proximal insert surface for topically treating the select equine hoof disorder.

24. The hoof boot assembly of claim 20 wherein the hoof structure dynamically develops, the hoof boot and the boot insert being dynamically engagable with the dynamically developing hoof structure, the dynamically engagable hoof boot and boot insert being dynamically conformable to the dynamically developing hoof structure.

25. The hoof boot assembly of claim 13 wherein the hoof structure is shod with a shoe, the shoe being attached to and substantially concentric with the distal wall terminus, the shoe being receivable intermediate the inner boot surface and the distal wall terminus.

26. The hoof boot assembly of claim 13 wherein the wall-opposing portion comprises a minimal wall portion thickness, a maximal wall portion thickness, and a plurality of infinitesimal incremental wall portion thicknesses extending intermediate the minimal wall portion thickness and the maximal wall portion thickness, the sole-opposing portion comprising a plurality of regional sole portion thicknesses, the regional sole thicknesses comprising a maximal sole thickness.

27. The hoof boot assembly of claim 26 wherein the anterior toe region comprises a distal anterior toe region thickness, the distal anterior toe region thickness being substantially equal in magnitude to the maximal sole thickness, the maximal sole thickness being about twice the minimal wall portion thickness.

28. The hoof boot assembly of claim 27 wherein the minimal wall portion thickness has a measured magnitude of about 0.25 inches and the maximal wall portion thickness and the regional sole portion thickness are each selected from a thickness range, the thickness range ranging from about 0.25 inches to about 0.50 inches.

29. A method for treating a select equine hoof disorder, the method comprising the steps of:
providing hoof cavity filling means and a select medicament, the hoof cavity filling means for releasably retaining the select medicament, for dynamically eliminating empty space within a hoof cavity, and for dynamically cushion-shielding a sole and a frog;
applying the select medicament to the hoof cavity filling means, the hoof cavity filling means releasably retaining the select medicament; and
filling the hoof cavity with the hoof cavity filling means, the select medicament being releasable thereby for treating a select equine hoof disorder.

30. The method of claim 29 wherein the hoof cavity filling means are defined by a hoof insert, the hoof cavity having a maximal cavity depth, the hoof insert comprising a proximal insert surface, a distal insert surface, and a relaxed insert thickness, the maximal cavity depth being lesser in magnitude than the relaxed insert thickness, the proximal insert surface being compressibly form-fit to the sole and the frog, the hoof insert dynamically eliminating empty space intermediate the distal insert surface and the sole and the frog and dynamically cushion-shielding the sole and the frog.

31. The method of claim 29 comprising additional steps after filling the hoof cavity with the cavity filling means, the additional steps comprising:
providing fill retainment means, the fill retainment means for selectively retaining the hoof cavity filling means and select medicament in the hoof cavity; and
selectively retaining the hoof cavity filling means and the select medicament in the hoof cavity for treating the select equine hoof disorder.

32. The method of claim 31 wherein the fill retainment means are defined by a hoof boot, the hoof boot comprising a select elastic material, an inner boot surface, an outer boot surface, a distal sole-opposing portion, a proximally-extending, wall-hugging portion, an anterior toe region, a medial quarter region, a lateral quarter region, and a posterior heel region, the hoof boot being attachable to a hoof structure, the hoof structure comprising a wall, a heel, the sole, the frog, and a coronary band, the wall comprising a toe, medial and lateral quarters, and a distal wall terminus, the sole-opposing and wall-hugging portions being elastically tensioned to envelope the wall and the heel in selective adjacency to the coronary band for preventing coronary band disruption.

33. The method of claim 32 wherein the inner boot surface comprises select anatomy-conforming, boot-positioning means, the select anatomy-conforming, boot-positioning means for aligning the hoof boot relative to the hoof structure.

34. The method of claim 33 wherein the select anatomy-conforming, boot-positioning means are selectively defined by the group consisting of inferior hoof-positioning structure and posterior hoof-positioning structure, the inferior hoof-positioning structure being defined by a peripheral wall-opposing groove and a cavity-opposing portion at the sole-opposing portion, the wall-opposing groove extending anteriorly from the posterior heel region along the medial and lateral quarter regions to the anterior toe region, the cavity-opposing portion extending anteriorly from the posterior heel region intermediate the wall-opposing groove, the wall-opposing groove being received in distal adjacency to the distal wall terminus at the toe and quarters for properly positioning the sole-opposing portion relative to the distal wall terminus, the posterior hoof-positioning structure being defined by a bar-locating protrusion at the posterior heel region, the bar-locating protrusion being receivable intermediate the medial and lateral bars for properly positioning the posterior heel region relative to the heel.

35. A hoof boot kit for selectively outfitting at least one hoof structure, the hoof boot kit comprising at least one select, anatomically-specific hoof boot, each hoof boot comprising a select elastic material, an inner boot surface, an outer boot surface, a distal sole-opposing portion, a proximally-extending, wall-opposing portion, an anterior toe region, medial and lateral quarter regions, and a posterior heel region.

36. The hoof boot kit of claim 35 wherein each select, anatomically-specific hoof boot is selected from the group consisting of a fore leg hoof boot and a hind leg hoof boot, the wall-opposing portion of the fore leg hoof boot proximally extending from the sole-opposing portion at the anterior toe region in a first angle of inclination, the wall-opposing portion of the hind leg hoof boot proximally extending from the sole-opposing portion at the anterior toe region in a second angle of inclination, the second angle of inclination being greater in magnitude than the first angle of inclination.

37. The hoof boot kit of claim 35 wherein the inner boot surface comprises select anatomy-conforming, boot-positioning means, the select anatomy-conforming, boot-positioning means for aligning each select, anatomically-specific hoof boot relative to each hoof structure.

38. The hoof boot assembly of claim 37 wherein the select anatomy-conforming, boot-positioning means are selectively defined by the group consisting of inferior hoof-positioning structure and posterior hoof-positioning structure, the inferior hoof-positioning structure being defined by a peripheral wall-opposing groove and a cavity-opposing portion at the sole-opposing portion, each wall-opposing groove extending anteriorly from the posterior heel region along the medial and lateral quarter regions to the anterior toe region, each cavity-opposing portion extending anteriorly from the posterior heel region intermediate the wall-opposing groove, the wall-opposing groove being receivable in distal adjacency to a distal wall terminus of a hoof structure for properly positioning the sole-opposing portion relative to the distal wall terminus, the posterior hoof-positioning structure being defined by a bar-locating protrusion at the posterior heel region, each bar-locating protrusion being receivable intermediate medial and lateral bars of the hoof structure for properly positioning the posterior heel region relative to a heel of the hoof structure.

39. The hoof bit kit of claim 35 wherein the wall-opposing portion comprises a proximal terminus, the proximal terminus being spatially located for outfitted placement in selective adjacency to a coronary band of a hoof structure, the selectively adjacent outfitted placement being selected from a spatial grouping, the spatial grouping consisting of a distally adjacent proximal terminus and a proximally adjacent proximal terminus, the distally adjacent proximal terminus being spatially located for outfitted placement in distal adjacency to the coronary band, the proximally adjacent proximal terminus being spatially located for outfitted placement in superficial adjacency to a pastern joint of an equine leg.

40. The hoof boot kit of claim 39 wherein the select elastic material is trimmable and each outer boot surface at the wall-opposing portion comprises a plurality of substantially concentric score indicia, the trimmable select elastic material and the score indicia for cooperatively enabling a user to selectively locate each proximal terminus.

41. The hoof boot kit of claim 35 comprising at least one boot insert for filling at least one hoof cavity, each hoof cavity comprising a sole, a frog, and a maximal cavity depth, each boot insert comprising a distal insert surface, a proximal insert surface, and a relaxed insert depth extending intermediate the distal and proximal insert surfaces, the distal insert surface being cooperatively associated with the inner boot surface at the sole-opposing region, the maximal cavity depth being lesser in magnitude than the relaxed insert depth, the proximal insert surface being compressibly form-fittable to the sole and the frog.

42. The hoof boot kit of claim 41 wherein each boot insert comprises a select viscoelastic foam material.

43. The hoof boot kit of claim 42 wherein the viscoelastic foam material comprises interstitial pores, the interstitial pores for releasably receiving at least one select medicament, each select medicament for effectively treating a select equine hoof disorder.

44. The hoof boot kit of claim 43 comprising at least one select medicament, each select medicament being releasably receivable by the interstitial pores for treating the select equine hoof disorder.

45. The hoof boot kit of claim 36 wherein each outer boot surface comprises select coloration, the select coloration for ornamentally outfitting a hoof structure.

46. The hoof boot kit of claim 35 wherein each wall-opposing portion comprises a minimal wall portion thickness, a maximal wall portion thickness, and a plurality of infinitesimal incremental wall portion thicknesses extending intermediate the minimal wall portion thickness and the maximal wall portion thickness, each sole-opposing portion comprising a plurality of regional sole portion thicknesses, the regional sole thicknesses comprising a maximal sole thickness.

47. The hoof boot assembly of claim 46 wherein each anterior toe region comprises a distal anterior toe region thickness, each distal anterior toe region thickness being substantially equal in magnitude to the maximal sole thickness, the maximal sole thickness being about twice the minimal wall portion thickness.

48. The hoof boot assembly of claim 47wherein the minimal wall portion thickness has a measured magnitude of about 0.25 inches and the maximal wall portion thickness and the regional sole portion thickness are each selected from a thickness range, the thickness range ranging from about 0.25 inches to about 0.50 inches.

49. A therapeutic hoof boot assembly for remedying a select equine hoof disorder, the therapeutic hoof boot assembly comprising, in combination:
an elastic hoof boot, the hoof boot comprising an inner boot surface, an outer boot surface, a distal sole-opposing portion, a proximally-extending, wall-opposing portion, an anterior toe region, a medial quarter region, a lateral quarter region, and a posterior heel region, the wall-opposing portion comprising a proximal terminus; and
a boot insert, the boot insert comprising a select viscoelastic foam, a distal insert surface, a proximal insert surface, and a substantially uniform relaxed insert thickness, the select viscoelastic foam comprising medicament-bearing interstitial pores, the distal insert surface being removably engageable with the inner boot surface at the sole-opposing portion, the hoof boot being attachable to an equine leg, the equine leg comprising a pastern joint and a hoof structure, the hoof structure comprising a wall, a heel, a sole, a frog, a coronary band, and a hoof cavity, the hoof cavity comprising a maximal cavity depth, the wall comprising a toe, medial and lateral quarters, medial and lateral bars, and a distal wall terminus, the wall-opposing and sole-opposing portions being elastically tensioned to snugly envelope the wall and the heel, the maximal cavity depth being lesser in magnitude than the insert thickness, the proximal insert surface being compressibly form-fit to the sole and the frog, the interstitial pores releasing medicament via the compressible form-fit proximal insert surface for topically treating the select equine hoof disorder.

50. The therapeutic hoof boot assembly of claim 49 wherein the inner boot surface comprises select anatomy-conforming, boot-positioning means, the select anatomy-conforming, boot-positioning means for aligning the hoof boot relative to the hoof structure.

51. The therapeutic hoof boot assembly of claim 49 wherein the proximal terminus is located in selective adjacency to the coronary band for preventing coronary band irritation,

52. The therapeutic hoof boot assembly of claim 51 wherein the proximal terminus is located in selective adjacency to the coronary band as selected from a spatial grouping the spatial grouping consisting of a distally adjacent proximal terminus and a proximally adjacent proximal terminus, the distally adjacent proximal terminus being spatially located in distal adjacency to the coronary band, the proximally adjacent proximal terminus being spatially located in superficial adjacency to the pastern joint.

53. A therapeutic hoof boot assembly usable in combination with a hoof structure, the hoof structure comprising a wall, a heel, a sole, a frog, a coronary band, and a hoof cavity, the hoof cavity comprising a maximal cavity depth, the wall comprising a toe, medial and lateral quarters, medial and lateral bars, and a distal wall terminus, the therapeutic hoof boot assembly comprising, in combination:
a hoof boot, the hoof boot comprising an inner boot surface, an outer boot surface, a distal sole-opposing portion, a proximally-extending, wall-opposing portion, an anterior toe region, a medial quarter region, a lateral quarter region, and a posterior heel region, the sole-opposing and wall-opposing portions being integrally and continuously formed with one another, the wall-opposing portion comprising a proximal terminus; and
a boot insert, the boot insert comprising a compressible, form-fitting material, a distal insert surface, a proximal insert surface, and a substantially uniform relaxed insert thickness, the form-fitting material for releasably receiving a medicament, the distal insert surface being removably engageable with the inner boot surface at the sole-opposing portion, the wall-opposing and sole-opposing portions being elastically tensioned to snugly envelope the wall and the heel, the maximal cavity depth being lesser in magnitude than the insert thickness, the proximal insert surface being compressibly form-fit to the sole and the frog, the form-fitting material for releasing medicament via the compressible form-fit proximal insert surface for topically treating a select hoof disorder.

54. The therapeutic hoof boot assembly of claim 53 wherein the proximal terminus is located in selective adjacency to the coronary band for preventing coronary band irritation.

55. The therapeutic hoof boot assembly of claim 54 wherein the proximal terminus is located in selective adjacency to the coronary band as selected from a spatial grouping, the spatial grouping consisting of a distally adjacent proximal terminus and a proximally adjacent proximal terminus, the distally adjacent proximal terminus being spatially located in distal adjacency to the coronary band, the proximally adjacent proximal terminus being spatially located in superficial adjacency to the pastern joint.

56. The therapeutic hoof boot assembly of claim 53 wherein the inner boot surface comprises select anatomy-conforming, boot-positioning means, the select anatomy-conforming, boot-positioning means for aligning the hoof boot relative to the hoof structure.
